(19) United States
(12) Patent Application Publication
(10) Pub. No.: US 2026/0319171 A1
(43) Pub. Date: Oct. 15, 2026

(54) OPTICAL TRANSMISSION/RECEPTION DEVICE AND OPTICAL TRANSMISSION APPARATUS

(71) Applicant: TDK Corporation, Tokyo (JP)

(72) Inventors: Shigeru MIEDA, Tokyo (JP); Hideaki FUKUZAWA, Tokyo (JP); Jiro YOSHINARI, Tokyo (JP); Tomohito MIZUNO, Tokyo (JP)

(73) Assignee: TDK Corporation, Tokyo (JP)

(21) Appl. No.: 19/642,265

(22) Filed: Apr. 8, 2026

(30) Foreign Application Priority Data
Apr. 11, 2025 (JP) 2025-065710
Feb. 16, 2026 (JP) 2026-022764

(51) Int. Cl. G02B 6/12; H04B 10/40

(52) U.S. Cl. CPC G02B 6/12004; H04B 10/40; G02B 2006/12121; G02B 2006/12142; G02B 2006/12164

(57) ABSTRACT

The optical transmission/reception device 3 has an optical transmission layer 200 and an optical receiving layer 250 vertically coupled. The optical transmission layer 200 is equipped with a splitter 19 that branches a part of the wavelength-divided modulated light of the laser light or a part of the wavelength-division multiplexed light and guides the branched light to a region above or below the substrate 10. The optical receiving layer 250 includes a first receiving-side waveguide 40 optically coupled to a waveguide of an external optical circuit, a first light detection element 42 that converts light propagating through the first receiving-side waveguide 40 into an electrical signal, and a second light detection element 43 that converts a part of each modulated light branched by the splitter 19 or a part of the multiplexed light into an electrical signal.

### CROSS-REFERENCE TO RELATED APPLICATIONS

This application claims a priority, under the Paris Convention, to Japanese Patent Application No. 2025-065710 filed on Apr. 11, 2025 and Japanese Patent Application No. 2026-022764 filed on Feb. 16, 2026, the entirety of which are incorporated herein by reference.

### TECHNICAL FIELD

The present disclosure relates to an optical transmission/reception device and an optical transmission apparatus.

### BACKGROUND

High-density interconnection devices are known in the form of cards that can be plugged into a backplane, with electrical connections along a single (pluggable) edge, and all remaining connections made by optical fibers (see, for example, China Patent Application Publication No. 111095061). Representative examples also include an on-board light source and silicon photonics-based circuitry to provide optical transceiver functionality. An array of passively aligned fibers is used for I/O connections to external components and connections between the laser light source and the on-board silicon photonics.

As recognized by the present inventors, since the advent of generative AI, there has been an increasing demand for improved GPU performance. On the other hand, from the perspective of thermal limitations, there is a limit to the speedup that relies on electronic devices and electrical wiring.

Therefore, attention has been focused on using optical communication technology, which has traditionally been used for long-distance communication, as an optical interconnect to connect electronic devices. The connection between electronic devices requires both low latency and high density. For this reason, there is a demand for an integrated optical device that integrates an optical receiving device and an optical transmission device to be made compact and highly dense.

However, the high-density interconnect device disclosed in China Patent Application Publication No. 111095061 has a transmitting circuit and a reception circuit formed on the same plane, and does not meet the demand for compactness and high density.

### SUMMARY

One aspect of the present disclosure provides an optical transmission/reception device in which an optical transmission layer and an optical receiving layer are vertically coupled. The optical transmission layer comprises, on the same substrate, a laser light source that emits laser light, an input-side waveguide optically coupled to the laser light source, an optical frequency comb generator that generates an optical frequency comb from the laser light propagating through the input-side waveguide, a demultiplexer that demultiplexes the optical frequency comb into individual optical frequency modes, a plurality of branching waveguides that propagate the multiple demultiplexed light beams demultiplexed by the demultiplexer, a plurality of intensity modulators that respectively modulate the intensity of the multiple demultiplexed light beams propagating through the plurality of branching waveguides, a multiplexer for multiplexing the multiple modulated light beams intensity-modulated by the multiple intensity modulators, a splitter that branches a part of each of the modulated light beams intensity-modulated by each of the intensity modulators or a part of the multiplexed light multiplexed by the multiplexer, and guides the branched light to a region above or below the substrate, and an output-side waveguide which propagates the multiplexed light. The optical receiving layer comprises a receiving-side waveguide optically coupled to a waveguide of an external optical circuit, a first light detection element that converts light propagating through the receiving-side waveguide into an electrical signal, and a second light detection element that converts a part of each of the modulated light beams branched by the splitter or a part of the multiplexed light into an electrical signal.

One aspect of the present disclosure provides an optical transmission apparatus comprises the above optical transmission/reception device, a semiconductor electronic circuit, and an optical circuit board having one or more optical circuit board layers. The optical circuit board is the external optical circuit. The semiconductor electronic circuit outputs an intensity modulation signal for intensity modulating the multiple demultiplexed light beams propagating through the multiple branching waveguides. The intensity modulation signal is input to the multiple intensity modulators, and at least one of the output-side waveguide and the receiving-side waveguide is optically coupled to the end face of the waveguide in the optical circuit board layer.

### BRIEF DESCRIPTION OF DRAWINGS

FIG. 1 shows a perspective view of an optical transmission device according to a first embodiment of the present disclosure.

FIG. 2 shows a block diagram of an optical transmission system according to the first embodiment of the present disclosure.

FIG. 3 shows an explanatory diagram of the operation of the optical transmission system according to the first embodiment of the present disclosure.

FIG. 4A shows a schematic plan view of a phase modulator (part 1) in an optical transmission device according to the first embodiment of the present disclosure.

FIG. 4B shows a cross-sectional view taken along line A-A in FIG. 4A.

FIG. 5A shows a schematic plan view of a phase modulator (part 2) in an optical transmission device according to the first embodiment of the present disclosure.

FIG. 5B shows a cross-sectional view taken along line A-A in FIG. 5A.

FIG. 6A shows a cross-sectional view of a hybrid-type phase modulator including a c-axis oriented oxide film.

FIG. 6B shows a cross-sectional view of a hybrid-type phase modulator including an a-axis oriented oxide film.

FIG. 7A shows a cross-sectional view of a modified example of a hybrid-type phase modulator including a c-axis oriented oxide film.

FIG. 7B shows a cross-sectional view of a modified example of a hybrid-type phase modulator including an a-axis oriented oxide film.

FIG. 8A shows a schematic plan view of an intensity modulator (part 1) in an optical transmission device according to the first embodiment of the present disclosure.

FIG. 8B shows a cross-sectional view taken along line A-A in FIG. 8A.

FIG. 9A shows a schematic plan view of an intensity modulator (part 2) in an optical transmission device according to the first embodiment of the present disclosure.

FIG. 9B shows a cross-sectional view taken along line A-A in FIG. 9A.

FIG. 10A shows a cross-sectional view of a hybrid-type intensity modulator including a c-axis oriented oxide film.

FIG. 10B shows a cross-sectional view of a hybrid-type intensity modulator including an a-axis oriented oxide film.

FIG. 11A shows a cross-sectional view of a modified example of a hybrid-type intensity modulator including a c-axis oriented oxide film.

FIG. 11B shows a cross-sectional view of a modified example of a hybrid-type intensity modulator including an a-axis oriented oxide film.

FIG. 12 shows a diagram schematically illustrating a method for manufacturing an optical transmission device according to one embodiment.

FIG. 13 shows a conceptual diagram of an optical receiving device according to a second embodiment of the present disclosure.

FIG. 14 shows a cross-sectional view (part 1) of an optical receiving device according to the second embodiment of the present disclosure.

FIG. 15 shows a cross-sectional view (part 2) of an optical receiving device according to the second embodiment of the present disclosure.

FIG. 16 shows a cross-sectional view (part 3) of an optical receiving device according to the second embodiment of the present disclosure.

FIG. 17 shows a cross-sectional view of a magnetic element in an optical receiving device according to the second embodiment of the present disclosure.

FIG. 18A shows an XZ cross-sectional view showing an example of the arrangement of a magnetic element in an optical receiving device according to the second embodiment of the present disclosure.

FIG. 18B shows a YZ cross-sectional view showing an example of the arrangement of a magnetic element in an optical receiving device according to the second embodiment of the present disclosure.

FIG. 19 shows a conceptual diagram of an optical receiving device according to the first modified example of the present disclosure.

FIG. 20 shows a perspective view of an optical receiving device according to the first modified example of the present disclosure.

FIG. 21 shows a conceptual diagram of an optical receiving device according to the second modified example of the present disclosure.

FIG. 22 shows a perspective view of an optical transmission/reception device according to a third embodiment of the present disclosure.

FIG. 23 shows a planar perspective view of an optical transmission/reception device according to the third embodiment of the present disclosure.

FIG. 24 shows a cross-sectional view taken along line B-B in FIG. 23.

FIG. 25 shows a cross-sectional view taken along line C-C in FIG. 23.

FIG. 26 shows a perspective view of an optical transmission apparatus according to a fourth embodiment of the present disclosure.

FIG. 27A shows a block diagram of an optical transmission apparatus according to the fourth embodiment of the present disclosure.

FIG. 27B shows a block diagram of an optical transmission apparatus according to the fourth embodiment of the present disclosure.

FIG. 28 shows a perspective view of an optical transmission apparatus according to a modified example of the present disclosure.

FIG. 29 shows a block diagram of an optical transmission apparatus according to the modified example of the present disclosure.

### DETAILED DESCRIPTION

The present disclosure provides an integrated optical transmission/reception device and optical transmission apparatus in which an optical receiving device and an optical transmission device are vertically coupled.

Hereinafter, an embodiment of the present disclosure will be described with reference to the drawings. Here, the dimensional ratios of each component in each drawing do not necessarily match the actual dimensional ratios.

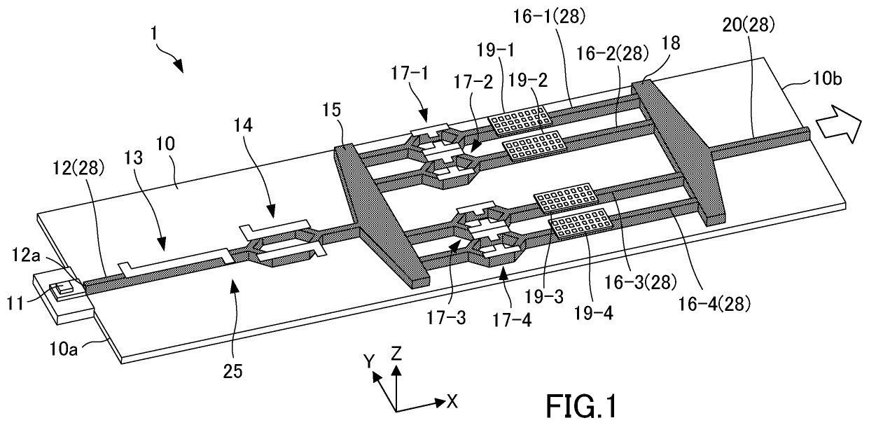

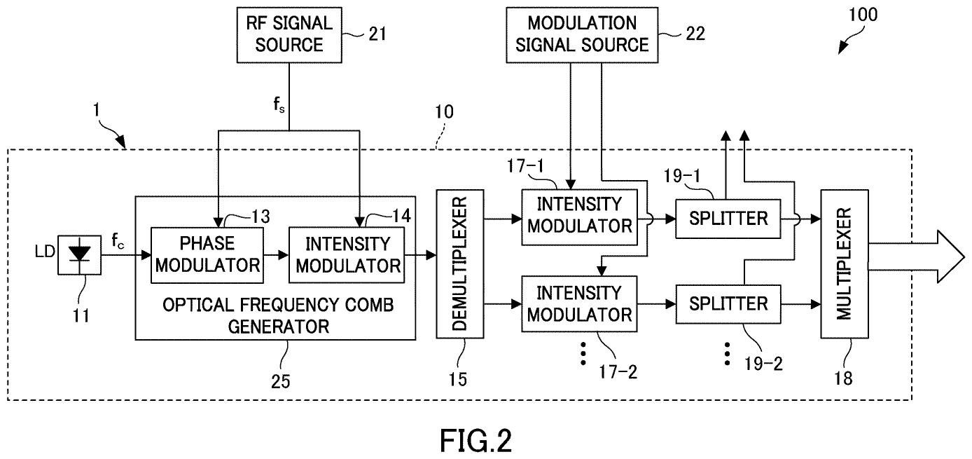

Hereinafter, a first embodiment of the present disclosure will be described. FIG. 1 is a perspective view of an optical transmission device 1 according to the first embodiment. FIG. 2 is a block diagram of an optical transmission system 100 including an optical transmission device 1. In FIG. 1, illustrations of parts other than a cladding 31 and a waveguide 28 of an oxide film 30, which will be described later, are omitted.

As shown in FIG. 1 and FIG. 2, the optical transmission device 1 includes a laser light source 11, an input-side waveguide 12, a phase modulator 13, an intensity modulator (first intensity modulator) 14, a demultiplexer 15, a plurality of branching waveguides 16 (16-1, . . . , 16-N), a plurality of intensity modulators (second intensity modulators) 17 (17-1, . . . , 17-N), a multiplexer 18, a plurality of splitters 19 (19-1, . . . , 19-N), and an output-side waveguide 20, all on the same substrate 10. Here, N is an integer equal to or greater than 2. The optical transmission system 100 includes the optical transmission device 1, an RF signal source 21, and a modulation signal source 22.

The substrate 10 has a refractive index lower than that of the oxide film 30, which is an ABX₃-type ferroelectric thin film such as a lithium niobate (LiNbO₃) film or a lithium tantalate (LiTaO₃) film, and may be any substrate on which the oxide film 30 can be formed as an epitaxial film. The substrate 10 is formed of silicon, silicon oxide, or sapphire, which can be processed by a semiconductor process. In the present embodiment, the substrate 10 is a sapphire single crystal substrate or a silicon single crystal substrate. The crystal orientation of the substrate 10 is not particularly limited. Lithium niobate films and lithium tantalate films have the property of being easily formed as c-axis oriented epitaxial films on substrates 10 of various crystal orientations. Since the crystals constituting a c-axis oriented lithium niobate film or lithium tantalate film have three-fold symmetry, it is desirable for the underlying substrate 10 to have the same symmetry. In the case of a sapphire single crystal substrate, a c-plane substrate is preferable, and in the case of a silicon single crystal substrate, a (111) plane substrate is preferable.

Here, an epitaxial film is a film that is aligned with the crystal orientation of the underlying substrate or film. When the film surface is the X-Y plane and the film thickness direction is the Z axis, the crystals are aligned in the X-axis, Y-axis, and Z-axis directions. Whether a film is an epitaxial film or not can be verified, for example, by checking the peak intensity and poles at the orientation position in 2θ-θ X-ray diffraction.

The laser light source 11 is a light source that emits laser light of a single frequency (single wavelength), for example, a semiconductor laser that oscillates in a single longitudinal mode. The wavelength band of the laser light output by the laser light source 11 is, for example, 405 nm to 1600 nm.

The input-side waveguide 12, the plurality of branching waveguides 16, and the output-side waveguide 20 include, for example, an ABX₃-type ferroelectric thin film such as c-axis oriented or a-axis oriented lithium niobate or lithium tantalate. Hereinafter, the input-side waveguide 12, the plurality of branching waveguides 16, and the output-side waveguide 20 are collectively referred to simply as the “waveguide 28.”

The waveguide 28 is a structure that forms a path along which light propagates. In this specification, light is not limited to visible light, but also includes infrared light, which has a longer wavelength than the visible light. The wavelength of the visible light is, for example, 380 nm or more and less than 800 nm. The wavelength of the infrared light is, for example, 800 nm or more and 1 mm or less. In this embodiment, it is particularly assumed that laser light with a wavelength of 405 nm to 1600 nm emitted from the laser light source 11 is incident on the waveguide 28.

The input-side waveguide 12 is optically coupled to the laser light source 11, and the laser light from the laser light source 11 is incident on the end 12a of the input-side waveguide 12, which is formed at the end face 10a of the substrate 10.

The phase modulator 13 and the intensity modulator 14 constitute an optical frequency comb generator 25 that generates an optical frequency comb from the laser light incident from the laser light source 11. The phase modulator 13 and the intensity modulator 14 are driven by a periodic electric signal with a frequency fs output from the RF signal source 21. In other words, the RF signal source 21 is a signal source that outputs a periodic electric signal for driving the phase modulator 13 and the intensity modulator 14.

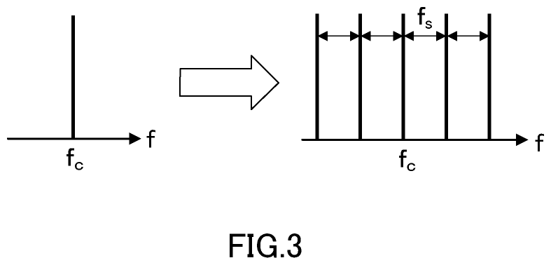

The phase modulator 13 phase-modulates the laser light propagating through the input-side waveguide 12 to generate a high-order modulation component of the laser light with frequency fc. The intensity modulator 14 intensity-modulates the high-order modulation component of the laser light with frequency fc that has been phase-modulated by the phase modulator 13. As a result, as shown in FIG. 3, an optical frequency comb is generated in which multiple optical frequency modes are arranged at intervals of frequency fs, centered on frequency fc.

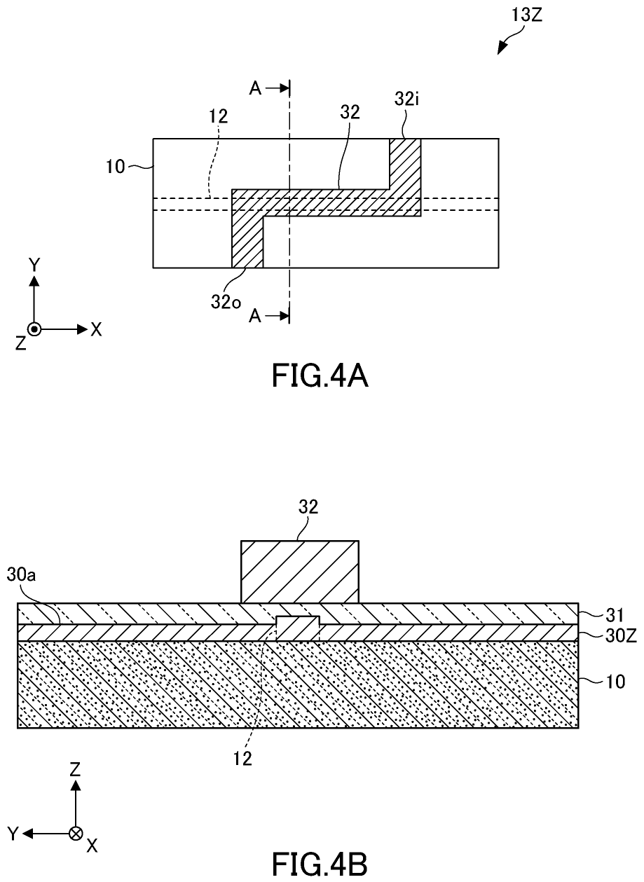

FIG. 4A is a plan view showing the configuration of the phase modulator 13Z (13) provided in the optical frequency comb generator 25, and illustrates the entire phase modulator including the traveling wave electrode. FIG. 4B is a cross-sectional view of the phase modulator 13Z, taken along line A-A in FIG. 4A.

As shown in FIGS. 4A and 4B, the phase modulator 13Z has a structure in which an oxide film 30Z (30), a clad 31, and a signal electrode 32 are stacked in this order on a substrate 10.

The waveguide 28 including the input-side waveguide 12 includes a ridge-shaped portion protruding from the upper surface 30a of the oxide film 30Z. The upper surface 30a is the upper surface of the portion of the oxide film 30Z other than the ridge-shaped portion. The ridge-shaped portion protrudes from the upper surface 30a in the Z direction and extends along the waveguide 28. The shape of the A-A cross section (cross section perpendicular to the light propagation direction) of the ridge-shaped portion can be any shape as long as it can guide light, and may be, for example, a dome shape, a triangular shape, or a rectangular shape. The width of the ridge-shaped portion in the Y direction is, for example, 0.3 μm or more and 5.0 μm or less, and the height of the ridge-shaped portion (protruding height from the upper surface 30a) is, for example, 0.1 μm or more and 1.0 μm or less.

The oxide film 30Z is a thin film of a ferroelectric ABX₃ crystal (ABX₃-type ferroelectric thin film), which is an electro-optic material, and is, for example, a c-axis oriented lithium niobate film or a c-axis oriented lithium tantalate film. That is, the c-axis of the oxide film 30Z is perpendicular to the main surface of the substrate 10. The oxide film 30Z is, for example, an epitaxial film epitaxially grown on the substrate 10. The oxide film 30Z may also be a lithium niobate film provided on an Si substrate via Y₂O₃ or S iO₂.

The composition of the lithium niobate film is LiₓNbA_{y}O_{z}. A is an element other than Li, Nb, and O. x is 0.5 to 1.2, preferably 0.9 to 1.05. y is 0 to 0.5. z is 1.5 to 4, preferably 2.5 to 3.5. The element A may be, for example, K, Na, Rb, Cs, Be, Mg, Ca, Sr, Ba, Ti, Zr, Hf, V, Cr, Mo, W, Fe, Co, Ni, Zn, Sc, or Ce, or a combination of two or more of these elements.

The thickness of the oxide film 30Z is, for example, 2μm or less. The thickness of the oxide film 30Z refers to the thickness of the portion other than the ridge-shaped portion. If the thickness of the oxide film 30Z is too thick, the crystallinity may be reduced. The thickness of the oxide film 30Z is, for example, about 1/10 or more of the wavelength of the light used. If the oxide film 30Z is thin, the light is less confined, and light leaks into the substrate 10 or the clad 31. If the oxide film 30Z is thin, the change in the effective refractive index of the waveguide 28, such as the input-side waveguide 12, may be small even if an electric field is applied to the oxide film 30Z.

One end 32i of the signal electrode 32 is a signal input end to which a periodic electric signal (modulation signal) with a frequency fs is input from the RF signal source 21. The other end 32o of the signal electrode 32 is connected to a reference potential through a termination resistor (not shown). The reference potential may be provided outside the optical transmission device 1. The reference potential may be ground G or may be other than ground G. As a result, the signal electrode 32 functions as a traveling wave electrode.

The refractive index of the input-side waveguide 12 changes due to the electric field applied to the oxide film 30Z from the signal electrode 32, and this change in refractive index causes the phase modulation of the laser light propagating through the input-side waveguide 12. The signal electrode 32 is provided so as to overlap the input-side waveguide 12 in order to phase-modulate the light propagating in the input-side waveguide 12.

The material of the signal electrode 32 may be any material with high electrical conductivity, but it is preferable to use a metal material with high electrical conductivity such as Au, Cu, Ag, or Pt in order to reduce the propagation loss of signals at high frequencies.

The cladding 31 is between the waveguide 28 such as the input-side waveguide 12 and various electrodes such as the signal electrode 32. The light propagates through the waveguide 28 while being totally reflected due to the difference in refractive index between the waveguide 28 and the cladding 31. The cladding 31 covers and protects the ridge shaped portion. The cladding 31 also functions as a buffer layer to prevent the light propagating through the waveguide 28 from being absorbed by various electrodes such as the signal electrode 32. The cladding 31 has a lower refractive index than the oxide film 30Z. The cladding 31 is, for example, SiO₂, Al₂O₃, MgF₂, La₂O₃, LaAlO₃, LaYO₃, ZnO, HfO₂, MgO, Y₂O₃, CaF₂, In₂O₃, or a mixture thereof.

The phase modulator 13Z (13) shown in FIGS. 4A and 4B has been described using the c-axis oriented oxide film 30Z as an example, but the phase modulator 13 may alternatively use the a-axis oriented oxide film 30X (30).

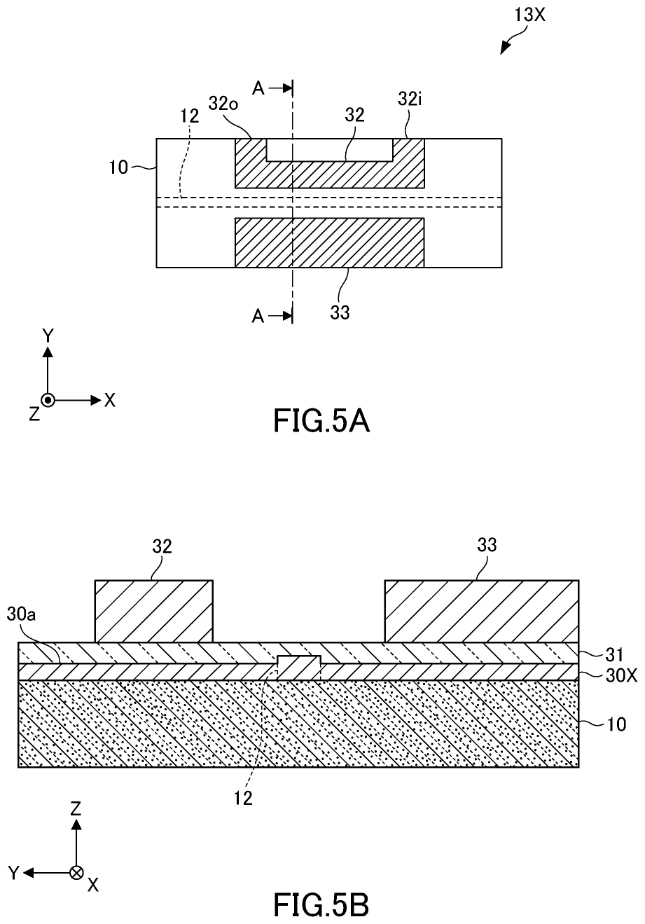

FIG. 5A is a plan view showing the configuration of a phase modulator 13X (13) that uses the a-axis oriented oxide film 30X, which is an ABX₃-type ferroelectric thin film, and illustrates the entire phase modulator 13X including the traveling wave electrode. FIG. 5B is a cross-sectional view of the phase modulator 13X, taken along line A-A in FIG. 5A.

As shown in FIGS. 5A and 5B, the phase modulator 13X has a signal electrode 32 provided along the input-side waveguide 12, and a ground electrode 33 provided at a position facing the signal electrode 32 across the input-side waveguide 12 in a plan view.

One end 32i of the signal electrode 32 is a signal input end to which a periodic electrical signal of frequency fs is input from the RF signal source 21. The other end 32o of the signal electrode 32 is connected to the ground electrode 33 through a termination resistor (not shown). The ground electrode 33 is connected to a reference potential. The reference potential may be provided outside the optical transmission device 1. The reference potential may be ground G or may be other than ground G. In this way, the signal electrode 32 and the ground electrode 33 function as traveling wave electrodes.

The refractive index of the input-side waveguide 12 changes due to the electric field applied to the oxide film 30X from the signal electrode 32 and the ground electrode 33, and this change in refractive index causes the laser light propagating through the input-side waveguide 12 to be phase modulated.

That is, in the phase modulator 13X, the arrangement of the signal electrode 32 and the ground electrode 33 differs from that of the phase modulator 13Z because the oxide film 30X is a-axis oriented. The other configurations and operations of the phase modulator 13X are the same as those of the phase modulator 13Z.

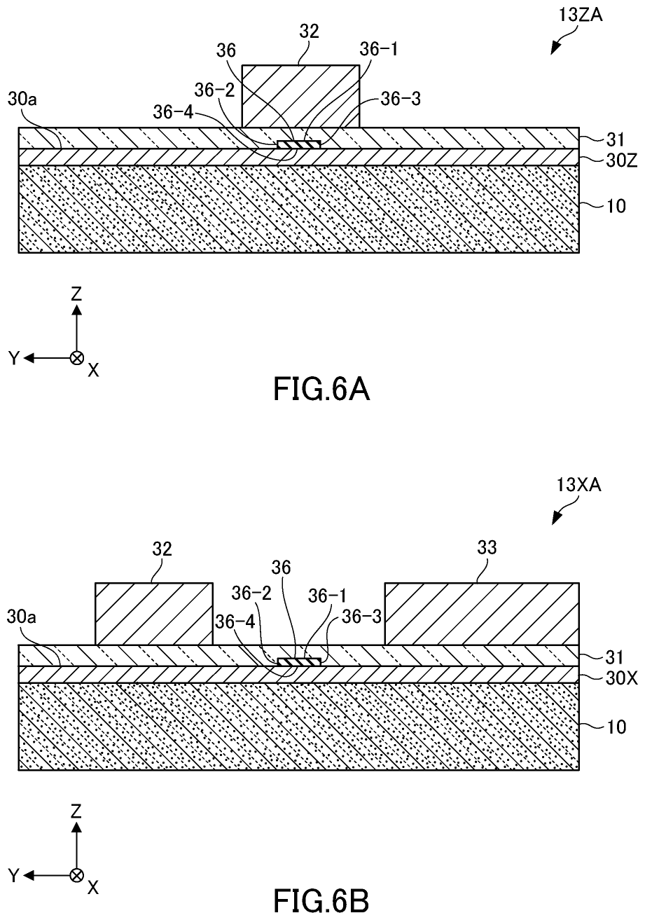

FIG. 6A is a cross-sectional view of a modified example of the phase modulator 13Z, namely the phase modulator 13ZA (13), and corresponds to the cross-sectional view taken along line A-A of FIG. 4A. Hereinafter, components having the same configuration as those of the phase modulator 13Z are denoted by the same names or reference numerals, and detailed explanation is omitted as appropriate. As shown in FIG. 6A, the phase modulator 13ZA includes the substrate 10, the c-axis oriented oxide film (ABX₃-type ferroelectric thin film) 30Z, a dielectric thin film (first dielectric thin film) 36, and the cladding (second dielectric thin film) 31. In this case, at least the input-side waveguide 12 among the waveguides 28 includes the oxide film 30Z, the dielectric thin film 36, and the cladding 31.

The oxide film 30Z is, for example, a sputtered thin film formed on the substrate 10 by a sputtering method. The dielectric thin film 36 is directly formed on the oxide film 30Z. In the phase modulator 13ZA, the oxide film 30Z has a flat plate shape that does not include a ridge-shaped portion protruding from the upper surface 30a. The cladding 31 is formed on the oxide film 30Z and the dielectric thin film 36. That is, the dielectric thin film 36 on the oxide film 30Z has its upper surface 36-1 and side surfaces 36-2 and 36-3 covered with the cladding 31.

The cross-sectional shape of the dielectric thin film 36 may be any shape that allows light to be guided, and may be, for example, a rectangle as shown in FIG. 6A, or a square, trapezoid, or triangle. In any of these shapes, the lower surface 36-4 of the dielectric thin film 36 is in direct contact with the upper surface 30a of the oxide film 30Z. The dielectric thin film 36 is formed of a material that transmits visible light without loss and has excellent optical waveguiding properties and workability. The dielectric thin film 36 is formed of, for example, elemental silicon, or an oxide, nitride, oxynitride, or carbide of silicon, aluminum, zirconium, or tantalum. In the present embodiment, it is formed of silicon nitride SiNₓ.

The cladding 31 functions as a cladding layer that confines light within the dielectric thin film 36 and the oxide film 30Z. Therefore, the refractive index of the cladding 31 is lower than the refractive indices of the oxide film 30Z and the dielectric thin film 36. For example, among the materials constituting the cladding 31, silicon dioxide (SiO₂) and aluminum oxide (Al₂O₃) have a large refractive index difference from the oxide film 30Z, which is an electro-optic material, and thus provide excellent light confinement in the oxide film 30Z.

The dielectric thin film 36 and the oxide film 30Z are optically coupled and function as the waveguide 28, which is a three-dimensional optical waveguide. Since the dielectric thin film 36 has a refractive index higher than that of the cladding 31, it suppresses excessive lateral spreading of light within the oxide film 30Z.

The method for forming the oxide film 30Z is not limited to the sputtering method, and film formation methods such as chemical vapor deposition (CVD) and the sol-gel method may also be used. The c-axis of the oxide film 30Z is oriented perpendicular to the main surface of the substrate 10, and when an electric field is applied parallel to the c-axis, the optical refractive index changes in proportion to the electric field.

The lithium niobate film constituting the oxide film 30Z may be, for example, a lithium niobate single-crystal thin film bonded onto a substrate by a Smart Cut (registered trademark) technique. Specifically, the method for forming this lithium niobate single-crystal thin film includes an ion implantation step, a wafer bonding step, and a layer separation step. In the ion implantation step, light ions such as hydrogen or helium are implanted into an LN donor wafer to form a damage layer at a predetermined depth below the wafer surface, the depth being determined by the implantation energy. In the wafer bonding step, the surface of the donor wafer into which ions have been implanted is directly bonded to the surface of a handling wafer (for example, a substrate composed of Si and SiO₂). An insulating layer (for example, SiO₂) may be formed on the handling wafer as needed. In the layer separation step, the bonded wafers are annealed, and a lithium niobate single-crystal thin film (transfer layer) is separated along the damage layer. The surface of the transfer layer after separation may be planarized as needed by chemical mechanical polishing or etching.

As another method for forming the oxide film 30Z, a technique in which a ferroelectric ABX₃ crystal substrate is thinned by polishing or sliced is also known. This method has the advantage that the same characteristics as those of a single crystal can be obtained, and it can be applied to the present embodiment.

The phase modulator 13ZA can be fabricated without using a bonding technique by laminating the oxide film 30Z, the dielectric thin film 36, the cladding 31, and the signal electrode 32 on the substrate 10 in this order. The hybrid-type phase modulator 13ZA fabricated in this manner has a low-defect film structure with precisely controlled film thicknesses.

FIG. 6B is a cross-sectional view of a modified example of the phase modulator 13X, namely the phase modulator 13XA (13), and corresponds to the cross-sectional view taken along line A-A of FIG. 5A. Hereinafter, components having the same configuration as those of the phase modulator 13X or 13ZA are denoted by the same names or reference numerals, and detailed explanation is omitted as appropriate. As shown in FIG. 6B, the phase modulator 13XA includes the substrate 10, the a-axis oriented oxide film (ABX₃-type ferroelectric thin film) 30X, the dielectric thin film (first dielectric thin film) 36, and the cladding (second dielectric thin film) 31. In this case, at least the input-side waveguide 12 among the waveguides 28 includes the oxide film 30X, the dielectric thin film 36, and the cladding 31.

The oxide film 30X in the phase modulator 13XA is a sputtered thin film having the same structure as the oxide film 30Z of the phase modulator 13ZA, except that it is a-axis oriented, and it has a flat plate shape that does not include a ridge-shaped portion protruding from the upper surface 30a.

The dielectric thin film 36 and the oxide film 30X are optically coupled and function as the waveguide 28, which is a three-dimensional optical waveguide. Since the dielectric thin film 36 has a refractive index higher than that of the cladding 31, it suppresses excessive lateral spreading of light within the oxide film 30X.

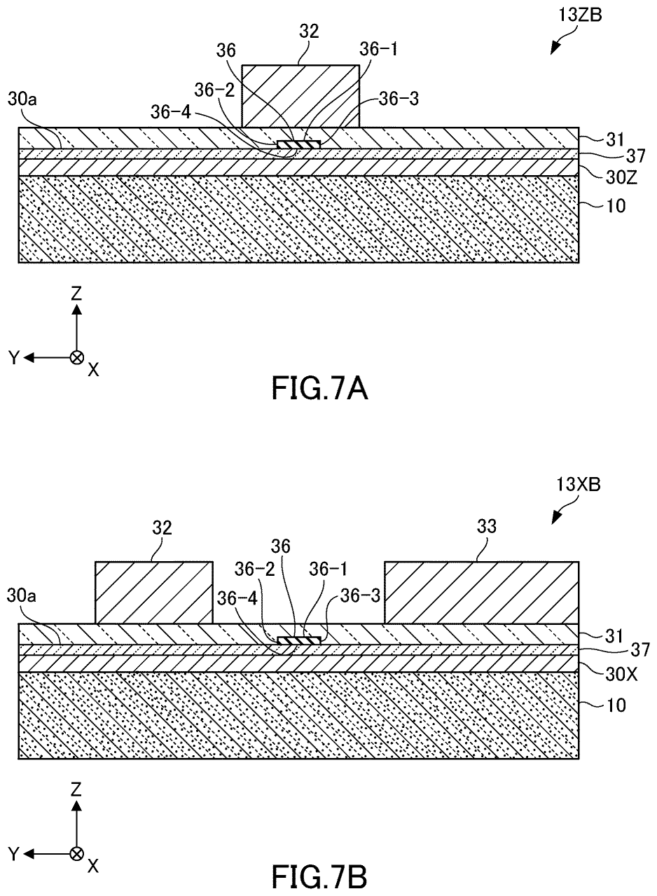

FIG. 7A is a cross-sectional view of a modified example of the phase modulator 13Z, namely the phase modulator 13ZB (13), and corresponds to the cross-sectional view taken along line A-A of FIG. 4A. Hereinafter, components having the same configuration as those of the phase modulators 13Z or 13ZA are denoted by the same names or reference numerals, and detailed explanation is omitted as appropriate. As shown in FIG. 7A, the phase modulator 13ZB includes the substrate 10, the c-axis oriented oxide film (ABX₃-type ferroelectric thin film) 30Z, the dielectric thin film (third dielectric thin film) 37, the dielectric thin film (first dielectric thin film) 36, and the cladding (second dielectric thin film) 31. In this case, at least the input-side waveguide 12 among the waveguides 28 includes the oxide film 30Z, the dielectric thin film 37, the dielectric thin film 36, and the cladding 31.

The oxide film 30Z in the phase modulator 13ZB has the same structure as the c-axis oriented oxide film 30Z of the phase modulator 13ZA, and it has a flat plate shape that does not include a ridge-shaped portion protruding from the upper surface 30a.

The dielectric thin film 37 is formed on the oxide film 30Z. The dielectric thin film 36 is formed on the dielectric thin film 37. That is, in the phase modulator 13ZB, the dielectric thin film 36 is formed on the oxide film 30Z via the dielectric thin film 37. The cladding 31 is formed on the dielectric thin film 37 and the dielectric thin film 36. Accordingly, the dielectric thin film 36 has its lower surface 36-4 covered by the dielectric thin film 37, and its upper surface 36-1 and side surfaces 36-2 and 36-3 covered by the cladding 31. The dielectric thin film 37, the dielectric thin film 36, and the cladding 31 constitute an embedded optical waveguide structure in which the dielectric thin film 36 is embedded by the dielectric thin film 37 and the cladding 31.

The dielectric thin film 37 and the cladding 31 function as cladding layers that confine light within the dielectric thin film 36 and the oxide film 30Z. Therefore, the refractive indices of the dielectric thin film 37 and the cladding 31 are lower than the refractive indices of the oxide film 30Z and the dielectric thin film 36.

The dielectric thin film 37 is made of a highly transparent material. For example, aluminum oxide (Al₂O₃), silicon dioxide (SiO₂), LaAlO₃, LaYO₃, ZnO, HfO₂, MgO, or Y₂O₃ may be used for the dielectric thin film 37. The dielectric thin film 37 and the cladding 31 may or may not be made of the same material.

The dielectric thin film 36 and the oxide film 30Z are optically coupled via the dielectric thin film 37. The dielectric thin film 36, the dielectric thin film 37, and the oxide film 30Z are optically coupled and function as the waveguide 28, which is a three-dimensional optical waveguide. Since the dielectric thin film 36 has a refractive index higher than that of the dielectric thin film 37, it suppresses excessive lateral spreading of light within the oxide film 30Z.

The phase modulator 13ZB can be fabricated without using a bonding technique by laminating the oxide film 30Z, the dielectric thin film 37, the dielectric thin film 36, the cladding 31, and the signal electrode 32 on the substrate 10 in this order. The hybrid-type phase modulator 13ZB fabricated in this manner has a low-defect film structure with precisely controlled film thicknesses.

FIG. 7B is a cross-sectional view of a modified example of the phase modulator 13X, namely the phase modulator 13XB (13), and corresponds to the cross-sectional view taken along line A-A of FIG. 5A. Hereinafter, components having the same configuration as those of the phase modulators 13X or 13XA are denoted by the same names or reference numerals, and detailed explanation is omitted as appropriate. As shown in FIG. 7B, the phase modulator 13XB includes the substrate 10, the a-axis oriented oxide film (ABX₃-type ferroelectric thin film) 30X, the dielectric thin film (third dielectric thin film) 37, the dielectric thin film (first dielectric thin film) 36, and the cladding (second dielectric thin film) 31. In this case, at least the input-side waveguide 12 among the waveguides 28 includes the oxide film 30X, the dielectric thin film 37, the dielectric thin film 36, and the cladding 31.

The oxide film 30X in the phase modulator 13XB has the same structure as the a-axis oriented oxide film 30X of the phase modulator 13XA, and it has a flat plate shape that does not include a ridge-shaped portion protruding from the upper surface 30a.

The dielectric thin film 36 and the oxide film 30X are optically coupled via the dielectric thin film 37. The dielectric thin film 36, the dielectric thin film 37, and the oxide film 30X are optically coupled and function as the waveguide 28, which is a three-dimensional optical waveguide. Since the dielectric thin film 36 has a refractive index higher than that of the dielectric thin film 37, it suppresses excessive lateral spreading of light within the oxide film 30X.

The phase modulators 13ZA, 13XA, 13ZB, and 13XB of the present embodiment can exhibit excellent electro-optic effects by using a lithium niobate thin film or a lithium tantalate thin film as the oxide film 30Z or the oxide film 30X. In addition, since the oxide film 30Z or the oxide film 30X is a sputtered thin film, the phase modulators 13ZA, 13XA, 13ZB, and 13XB offer excellent mass productivity and low cost. In the present embodiment, the waveguide 28 can be formed without processing the oxide film 30Z or the oxide film 30X, making it possible to suppress propagation loss caused by sidewall roughness or other factors resulting from waveguide processing.

The phase modulators 13ZA, 13XA, 13ZB, and 13XB of the present embodiment are not limited to the schematic cross-sectional configurations shown in FIGS. 6A, 6B, 7A, and 7B. For example, another dielectric thin film (not shown) may be provided on the side surfaces 36-2 and 36-3 of the dielectric thin film 36. The cladding 31 may also be further enhanced to strengthen its function as a cladding layer. The additional dielectric thin film may be formed of, for example, silicon dioxide or aluminum oxide, which have a large refractive index difference from the oxide films 30Z and 30X that serve as electro-optic materials, and which provide excellent light confinement into the oxide films 30Z and 30X.

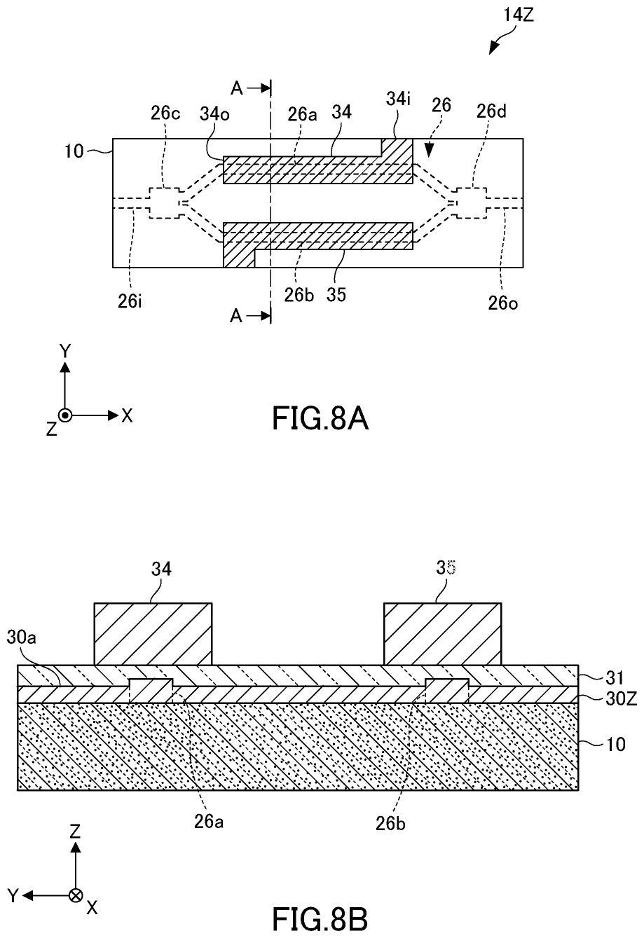

FIGS. 8A and 8B are plan views showing the configuration of the intensity modulator 14Z (14) included in the optical frequency comb generator 25, and show the entire intensity modulator including the traveling wave electrodes. FIG. 8B is a cross-sectional view of the intensity modulator 14Z, taken along line A-A in FIG. 8A.

As shown in FIGS. 8A and 8B, this intensity modulator 14Z has a structure in which an oxide film 30Z (30), a cladding 31, and electrodes 34, 35 (signal electrode 34 and ground electrode 35) are stacked in this order on a substrate 10. The intensity modulator 14Z also includes a Mach-Zehnder type waveguide 26 formed above the substrate 10 (positive Z direction) and having first and second waveguides 26a, 26b arranged parallel to each other. The Mach-Zehnder type waveguide 26 constitutes a part of the input-side waveguide 12.

The Mach-Zehnder type waveguide 26 is a waveguide having a structure of a Mach-Zehnder interferometer, and has first and second waveguides 26a, 26b branched by a branching section 26c from a single input-side waveguide 26i, and the first and second waveguides 26 a, 26 b are combined into a single output-side waveguide 26o through a combining section 26d. The input light to the input-side waveguide 26i is branched by the branching section 26c, travels through the first and second waveguides 26a, 26b, respectively, and is then multiplexed by the combining section 26d and output from the output-side waveguide 26o as modulated light.

One end 34i of the signal electrode 34 is a signal input end to which a periodic electrical signal of frequency fs is input from the RF signal source 21. The other end 34o of the signal electrode 34 is connected to the ground electrode 35 through a termination resistor (not shown). The ground electrode 35 is connected to a reference potential. The reference potential may be provided outside the optical transmission device 1. The reference potential may be ground G or may be other than ground G. In this way, the signal electrode 34 and the ground electrode 35 function as traveling wave electrodes.

The refractive indices of the first and second waveguides 26a and 26b change to +Δn and −Δn, respectively, due to the electric field applied to the oxide film 30Z from the signal electrode 34 and the ground electrode 35, and the phase difference between the pair of waveguides changes. The signal light modulated by this change in phase difference is output from the output-side waveguide 26o.

The signal electrode 34 is provided overlapping the first waveguide 26a in order to modulate the light traveling in the first waveguide 26a. The ground electrode 35 is provided overlapping the second waveguide 26b in order to modulate the light traveling in the second waveguide 26b.

The material of the signal electrode 34 and the ground electrode 35 may be any material having high electrical conductivity, but it is preferable to use a metal material having high electrical conductivity such as Au, Cu, Ag, or Pt in order to reduce the signal propagation loss at high frequencies.

The clad 31 should be thicker to reduce the light absorption of the signal electrode 34 and the ground electrode 35, and thinner to apply a high electric field to the first and second waveguides 26a and 26b. In other words, there is a trade-off relationship between the light absorption of the electrodes and the voltage applied to the electrodes, so it is necessary to set an appropriate film thickness according to the purpose. The higher the dielectric constant of the clad 31, the more preferable it is because it can reduce VπL (an index representing the electric field efficiency), and the lower the refractive index of the clad 31, the more preferable it is because it can be made thinner.

Here, Vπ is the half-wavelength voltage, which is defined as the difference between the voltage V1 at which the optical output of the intensity modulator is maximized and the voltage V2 at which it is minimized, and means the drive voltage. VπL is the product of the drive voltage, which is the voltage applied to the signal electrode 34, and the electrode length L of the signal electrode 34, and is one index that represents the performance of the intensity modulator. The smaller VπL indicates a smaller size and a lower driving voltage.

Although the intensity modulator 14Z shown in FIGS. 8A and 8B has been described using the c-axis oriented oxide film 30Z as an example, the intensity modulator 14 may instead use the a-axis oriented oxide film 30X.

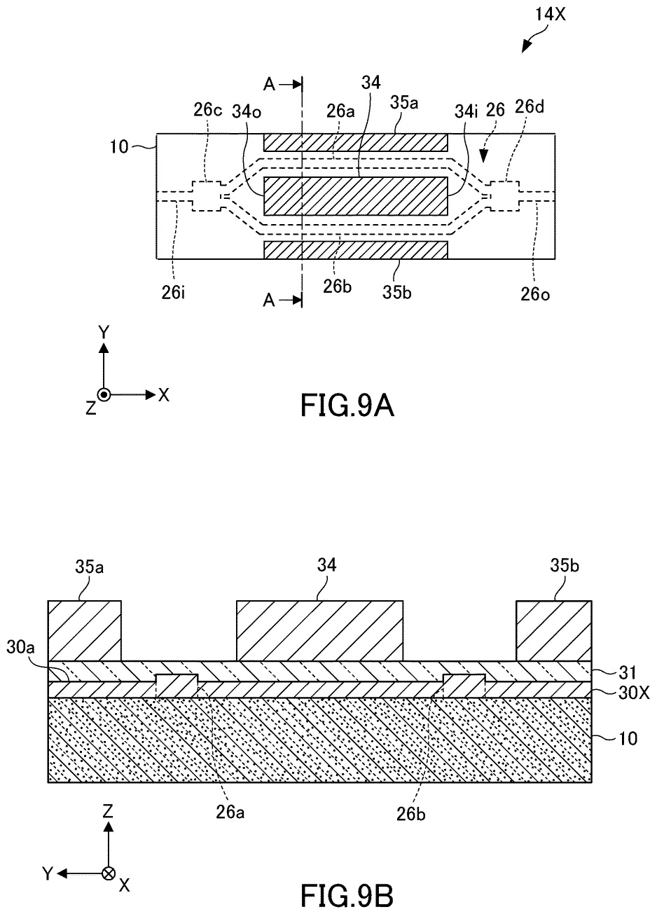

FIG. 9A is a plan view showing the configuration of the intensity modulator 14X (14) that uses the a-axis oriented oxide film 30X, and illustrates the entire intensity modulator 14X including the traveling wave electrode. FIG. 9B is a cross-sectional view of the intensity modulator 14X, corresponding to the cross-sectional view taken along line A-A of FIG. 9A.

As shown in FIGS. 9A and 9B, this intensity modulator 14X is formed above a substrate 10, and includes a Mach-Zehnder type waveguide 26 having first and second waveguides 26a and 26b arranged parallel to each other, a signal electrode 34 arranged between the first and second waveguides 26a and 26b in a plan view, a ground electrode 35a arranged at a position facing the signal electrode 34 across the first waveguide 26a in a plan view, and a ground electrode 35b arranged at a position facing the signal electrode 34 across the second waveguide 26b in a plan view.

The refractive indices of the first and second waveguides 26a and 26b change to +Δn and −Δn, respectively, due to the electric field applied to the oxide film 30X from the signal electrode 34 and the ground electrodes 35a and 35b, and the phase difference between the pair of waveguides changes. The signal light modulated by this change in phase difference is output from the output-side waveguide 26o.

That is, in the intensity modulator 14X, because the oxide film 30X is a-axis oriented, the arrangement of the signal electrode 34 and the ground electrodes 35a and 35b differs from that of the intensity modulator 14Z. The intensity modulator 14X can effectively reduce the half-wavelength voltage due to the a-axis orientation of the oxide film 30X. The other configurations and operations of the intensity modulator 14X are the same as those of the intensity modulator 14Z.

The intensity modulator 14 is not limited to the Mach-Zehnder type as described above, and may be a ring-type modulator. When the intensity modulator 14 is a ring-type modulator, the area occupied by the intensity modulator 14 on the substrate 10 can be reduced.

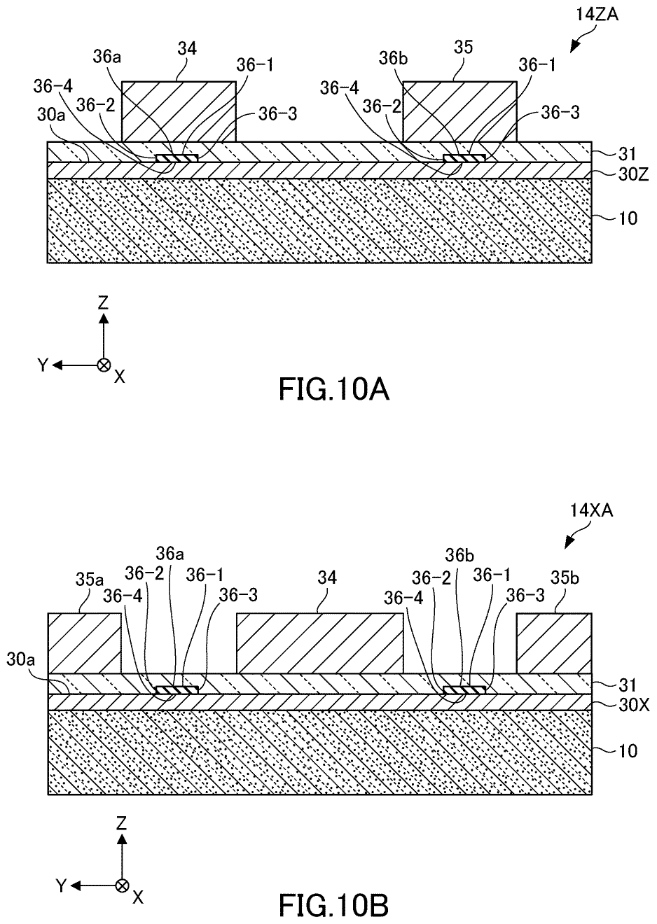

FIG. 10A is a cross-sectional view of a modified example of the intensity modulator 14Z, namely the intensity modulator 14ZA (14), and corresponds to the cross-sectional view taken along line A-A of FIG. 8A. Hereinafter, components having the same configuration as those of the intensity modulator 14Z and the phase modulator 13ZA are denoted by the same names or reference numerals, and detailed explanation is omitted as appropriate. As shown in FIG. 10A, the intensity modulator 14ZA includes the substrate 10, the c-axis oriented oxide film (ABX₃-type ferroelectric thin film) 30Z, the dielectric thin films (first dielectric thin films) 36a and 36b (36), and the cladding (second dielectric thin film) 31. In this case, at least the input-side waveguide 12 among the waveguides 28 includes the oxide film 30Z, the dielectric thin films 36a and 36b, and the cladding 31.

The dielectric thin films 36a and 36b are formed directly on the oxide film 30Z. In the intensity modulator 14ZA, the oxide film 30Z has a flat plate shape that does not include a ridge-shaped portion protruding from the upper surface 30a. The cladding 31 is formed on the oxide film 30Z and the dielectric thin films 36a and 36b. Accordingly, the dielectric thin films 36a and 36b on the oxide film 30Z have their upper surface 36-1 and side surfaces 36-2 and 36-3 covered by the cladding 31.

The dielectric thin films 36a and 36b and the oxide film 30Z are optically coupled and function as the first and second waveguides 26a and 26b, which are three-dimensional optical waveguides. Since the dielectric thin films 36a and 36b have refractive indices higher than that of the cladding 31, they suppress excessive lateral spreading of light within the oxide film 30Z.

FIG. 10B is a cross-sectional view of a modified example of the intensity modulator 14X, namely the intensity modulator 14XA (14), and corresponds to the cross-sectional view taken along line A-A of FIG. 9A. Hereinafter, components having the same configuration as those of the intensity modulators 14X or 14ZA are denoted by the same names or reference numerals, and detailed explanation is omitted as appropriate. As shown in FIG. 10B, the intensity modulator 14XA includes the substrate 10, the a-axis oriented oxide film (ABX₃-type ferroelectric thin film) 30X, the dielectric thin films (first dielectric thin films) 36a and 36b (36), and the cladding (second dielectric thin film) 31. In this case, at least the input-side waveguide 12 among the waveguides 28 includes the oxide film 30X, the dielectric thin films 36a and 36b, and the cladding 31.

The oxide film 30X in the intensity modulator 14XA is a sputtered thin film having the same structure as the oxide film 30Z of the intensity modulator 14ZA, except that it is a-axis oriented, and it has a flat plate shape that does not include a ridge-shaped portion protruding from the upper surface 30a.

The dielectric thin films 36a and 36b and the oxide film 30X are optically coupled and function as the first and second waveguides 26a and 26b, which are three-dimensional optical waveguides. Since the dielectric thin films 36a and 36b have refractive indices higher than that of the cladding 31, they suppress excessive lateral spreading of light within the oxide film 30X.

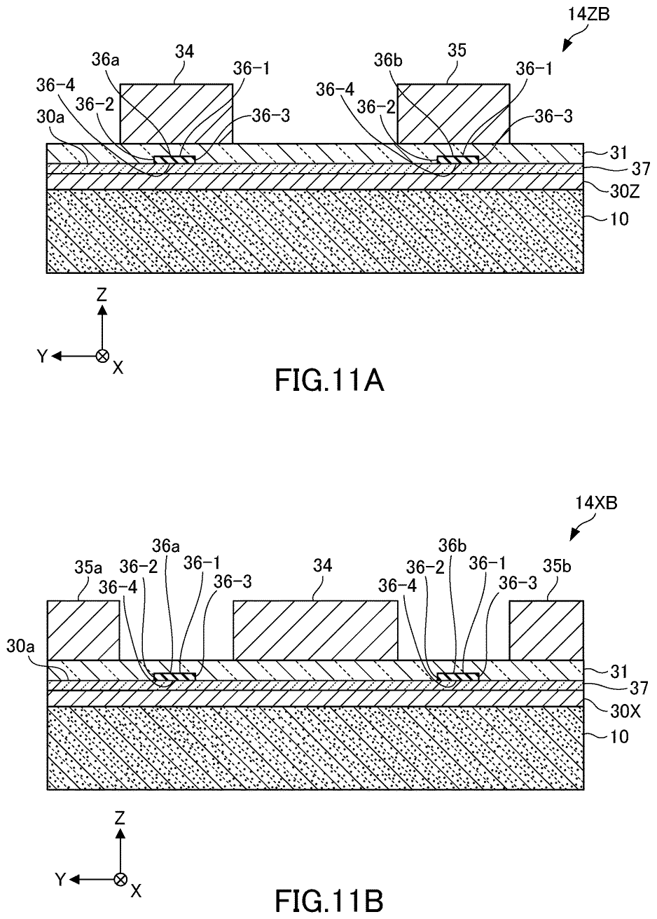

FIG. 11A is a cross-sectional view of a modified example of the intensity modulator 14Z, namely the intensity modulator 14ZB (14), and corresponds to the cross-sectional view taken along line A-A of FIG. 8A. Hereinafter, components having the same configuration as those of the intensity modulator 14Z or the phase modulator 13ZB are denoted by the same names or reference numerals, and detailed explanation is omitted as appropriate. As shown in FIG. 11A, the intensity modulator 14ZB includes the substrate 10, the c-axis oriented oxide film (ABX₃-type ferroelectric thin film) 30Z, the dielectric thin film (third dielectric thin film) 37, the dielectric thin films (first dielectric thin films) 36a and 36b (36), and the cladding (second dielectric thin film) 31. In this case, at least the input-side waveguide 12 among the waveguides 28 includes the oxide film 30Z, the dielectric thin film 37, the dielectric thin films 36a and 36b, and the cladding 31.

The oxide film 30Z in the intensity modulator 14ZB has the same structure as the c-axis oriented oxide film 30Z of the intensity modulator 14ZA, and it has a flat plate shape that does not include a ridge-shaped portion protruding from the upper surface 30a.

The dielectric thin film 37 is formed on the oxide film 30Z. The dielectric thin films 36a and 36b are formed on the dielectric thin film 37. That is, in the intensity modulator 14ZB, the dielectric thin films 36a and 36b are formed on the oxide film 30Z via the dielectric thin film 37. The cladding 31 is formed on the dielectric thin film 37 and the dielectric thin films 36a and 36b. Accordingly, the dielectric thin films 36a and 36b have their lower surface 36-4 covered by the dielectric thin film 37, and their upper surface 36-1 and side surfaces 36-2 and 36-3 covered by the cladding 31. The dielectric thin film 37, the dielectric thin films 36a and 36b, and the cladding 31 embed the dielectric thin films 36a and 36b between the dielectric thin film 37 and the cladding 31, thereby forming first and second embedded optical waveguide structures adjacent to each other.

The dielectric thin films 36a and 36b and the oxide film 30Z are optically coupled via the dielectric thin film 37. The dielectric thin films 36a and 36b, the dielectric thin film 37, and the oxide film 30Z are optically coupled and function as the first and second waveguides 26a and 26b, which are three-dimensional optical waveguides. Since the dielectric thin films 36a and 36b have refractive indices higher than that of the dielectric thin film 37, they suppress excessive lateral spreading of light within the oxide film 30Z.

FIG. 11B is a cross-sectional view of a modified example of the intensity modulator 14X, namely the intensity modulator 14XB (14), and corresponds to the cross-sectional view taken along line A-A of FIG. 9A. Hereinafter, components having the same configuration as those of the intensity modulator 14X or the phase modulator 13XB are denoted by the same names or reference numerals, and detailed explanation is omitted as appropriate. As shown in FIG. 11B, the intensity modulator 14XB includes the substrate 10, the a-axis oriented oxide film (ABX₃-type ferroelectric thin film) 30X, the dielectric thin film (third dielectric thin film) 37, the dielectric thin films (first dielectric thin films) 36a and 36b (36), and the cladding (second dielectric thin film) 31. In this case, at least the input-side waveguide 12 among the waveguides 28 includes the oxide film 30X, the dielectric thin film 37, the dielectric thin films 36a and 36b, and the cladding 31.

The oxide film 30X in the intensity modulator 14XB has the same structure as the a-axis oriented oxide film 30X of the intensity modulator 14XA, and it has a flat plate shape that does not include a ridge-shaped portion protruding from the upper surface 30a.

The dielectric thin films 36a and 36b and the oxide film 30X are optically coupled via the dielectric thin film 37. The dielectric thin films 36a and 36b, the dielectric thin film 37, and the oxide film 30X are optically coupled and function as the first and second waveguides 26a and 26b, which are three-dimensional optical waveguides. Since the dielectric thin films 36a and 36b have refractive indices higher than that of the dielectric thin film 37, they suppress excessive lateral spreading of light within the oxide film 30X.

The intensity modulators 14ZA, 14XA, 14ZB, and 14XB of the present embodiment can exhibit excellent electro-optic effects by using a lithium niobate thin film or a lithium tantalate thin film as the oxide film 30Z or the oxide film 30X. In addition, since the oxide films 30Z and 30X are sputtered thin films, the intensity modulators 14ZA, 14XA, 14ZB, and 14XB offer excellent mass productivity and low cost. In the present embodiment, the first and second waveguides 26a and 26b can be formed without processing the oxide film 30Z or the oxide film 30X, thereby suppressing propagation loss caused by sidewall roughness or the like resulting from waveguide processing.

The intensity modulators 14ZA, 14XA, 14ZB, and 14XB of the present embodiment are not limited to the schematic cross-sectional configurations shown in FIGS. 10A, 10B, 11A, and 11B. For example, another dielectric thin film (not shown) may be provided on the side surfaces 36-2 and 36-3 of the dielectric thin film 36a, and on the side surfaces 36-2 and 36-3 of the dielectric thin film 36b. The cladding 31 may also be further enhanced to strengthen its function as a cladding layer. The additional dielectric thin film may be formed of, for example, silicon dioxide or aluminum oxide, which have a large refractive index difference from the oxide films 30Z and 30X that serve as electro-optic materials, and which provide excellent light confinement into the oxide films 30Z and 30X.

The demultiplexer 15 is configured to demultiplex the optical frequency comb generated by the optical frequency comb generator 25 into individual optical frequency modes included in the optical frequency comb. That is, the demultiplexer 15 separates the optical frequency comb for each wavelength λ (λ₁, . . . , λ_{N}) (where N is an integer of 2 or more) corresponding to each optical frequency mode, and outputs the separated demultiplexed light beam. The demultiplexer 15 includes, for example, any one of a multimode interference waveguide (MMI), an arrayed waveguide grating (AWG), or a ring resonator.

The branching waveguides 16 (16-1, . . . , 16-N) are configured to propagate the multiple N demultiplexed light beams of wavelengths λ₁, . . . , λ_{N} demultiplexed by the demultiplexer 15.

The intensity modulators 17 (17-1, . . . , 17-N) are configured to modulate the intensity of each of the multiple N demultiplexed light beams of wavelengths λ₁, . . . , λ_{N} propagating through the branching waveguides 16. The configuration of the intensity modulator 17 is the same as that of the intensity modulator 14.

An intensity modulation signal is input from the modulation signal source 22 to one end 34i of the signal electrode 34 of each intensity modulator 17. The intensity modulation signal is, for example, a binary digital signal. Each intensity modulator 17-n (n is an integer equal to or greater than 1) intensity-modulates the demultiplexed light beam of wavelength λ_{N} according to the voltage of the intensity modulation signal, and outputs the intensity-modulated modulated light beam. That is, the modulation signal source 22 is a signal source that outputs an intensity modulation signal for intensity-modulating the multiple demultiplexed light beams propagating through the multiple branching waveguides 16.

The intensity modulator 17 is not limited to a Mach-Zehnder type, and may be a ring-type modulator. When the intensity modulator 17 is a ring-type modulator, the area occupied by the intensity modulator 17 on the substrate 10 can be reduced.

The multiplexer 18 multiplexes the multiple modulated light beams that have been intensity-modulated by the multiple intensity modulators 17. The multiplexed light multiplexed by the multiplexer 18, i.e., the wavelength division multiplexed optical signal, propagates through the output-side waveguide 20 and is output to an external optical circuit such as the optical circuit board 400 described later. The multiplexer 18 includes, for example, a multimode interference waveguide (MMI), an arrayed waveguide grating (AWG), or a ring resonator.

The output-side waveguide 20 is optically coupled to a waveguide of an external optical circuit, and propagates the multiplexed light multiplexed by the multiplexer 18.

The splitters 19 (19-1, . . . , 19-N) branch a part of each modulated light beam intensity-modulated by each intensity modulator 17, and propagate it upward or downward on the substrate 10. Here, “upward” refers to the positive Z direction, and “downward” refers to the negative Z direction. The splitters 19 are disposed midway through each branching waveguide 16 after each intensity modulator 17. The splitters 19 are, for example, a meta-mirror having a meta-diffraction grating, a diffraction grating, or a mirror.

The meta-diffraction grating is a metamaterial. The meta-diffraction grating is composed of multiple unit cells, each of which contains multiple meta-atoms. The meta-diffraction grating can change the distribution of the refractive index depending on the shape of the unit cells. The meta-mirror exhibits high reflectance when irradiated with light of a specific wavelength. The specific wavelength can be controlled by changing the configuration of the meta-diffraction grating.

Alternatively, the splitter 19 may split a part of the multiplexed light combined by the multiplexer 18, i.e., a portion of the wavelength division multiplexed optical signal, and propagate it above or below the substrate 10. In this case, one splitter 19 is disposed in the middle of the output-side waveguide 20 after the multiplexer 18.

The branched light beam split by the splitter 19 is output to an external optical circuit. The external optical circuit has a function of monitoring the branched light beam split by the splitter 19, and is, for example, the optical receiving device 2 described later.

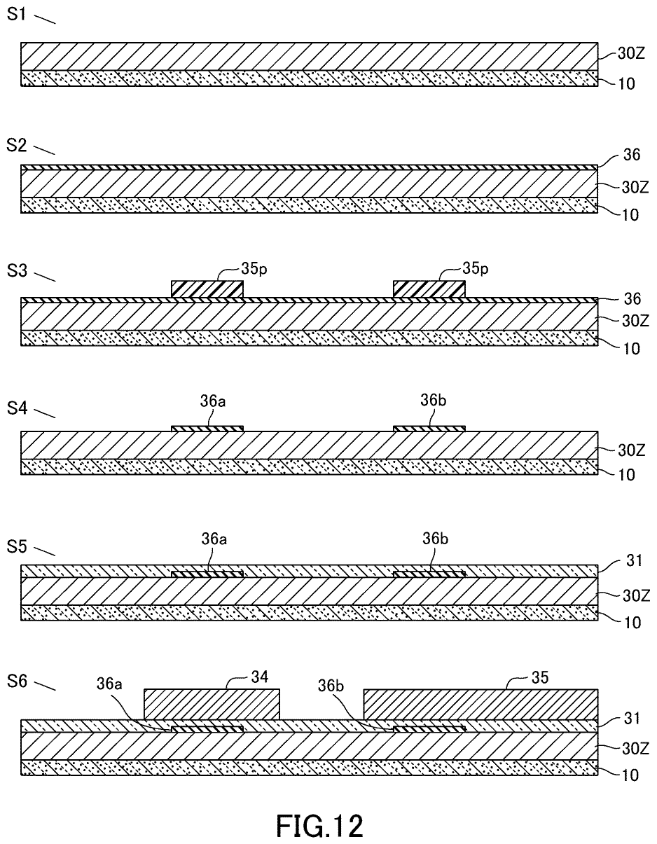

Next, a method for manufacturing the optical transmission device 1 according to an embodiment of the present disclosure will be described with reference to the drawings. FIG. 12 is a diagram schematically illustrating, as an example focusing on the portion of the intensity modulator 14ZA, a method for manufacturing the optical transmission device 1 according to an embodiment of the present disclosure.

As shown in FIG. 12, in manufacturing the optical transmission device 1, a sapphire single crystal substrate is prepared as the substrate 10, and an oxide film 30Z such as a lithium niobate film is formed over the entire main surface of the substrate 10 by sputtering. The upper surface of the oxide film 30Z is then planarized by chemical mechanical polishing (CMP) (step S1).

Next, a dielectric thin film 36 made of Si₃N₄ with a thickness of 100 nm to 1000 nm is formed on the upper surface of the oxide film 30Z by a CVD method (step S2).

Next, a photoresist is spin-coated onto the upper surface of the dielectric thin film 36 and cured. Then, exposure and development of the photoresist are performed using a photomask, thereby forming a resist pattern 35p corresponding to the dielectric thin films 36 a and 36b (step S3).

Next, the dielectric thin film 36 is etched using the resist pattern 35p as a mask, thereby forming the dielectric thin films 36a and 36b. As the etching method, RIE (reactive ion etching) or ion milling may be used. The resist pattern 35p is then removed (step S4).

Next, a cladding 31 made of SiO₂, Al₂O₃, or the like is formed on the oxide film 30Z and the dielectric thin films 36a and 36b by a CVD method. The upper surface of the cladding 31 is then planarized by CMP (step S5).

Thereafter, a signal electrode 34 and a ground electrode 35, which respectively cover the regions above the dielectric thin films 36a and 36b, are sequentially formed on the upper surface of the cladding 31 (step S6). In this manner, the optical transmission device 1 is manufactured in the present embodiment.

As described above, the optical transmission device 1 according to this embodiment can generate a wavelength division multiplexed optical signal from the laser light emitted from the laser light source 11. In addition, the optical transmission device 1 can extract a portion of the output light above or below the substrate 10 for monitoring. In addition, the optical transmission device 1 is configured by integrating the laser light source 11, the waveguide 28, the optical frequency comb generator 25, the demultiplexer 15, the intensity modulator 17, the multiplexer 18, and the splitter 19 on the same substrate 10, so that it can be made compact and highly dense.

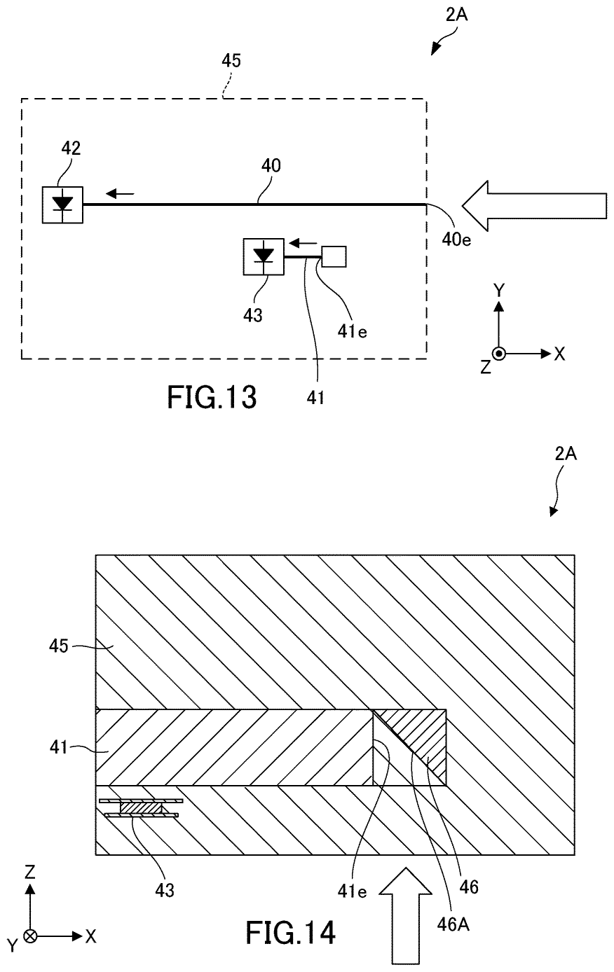

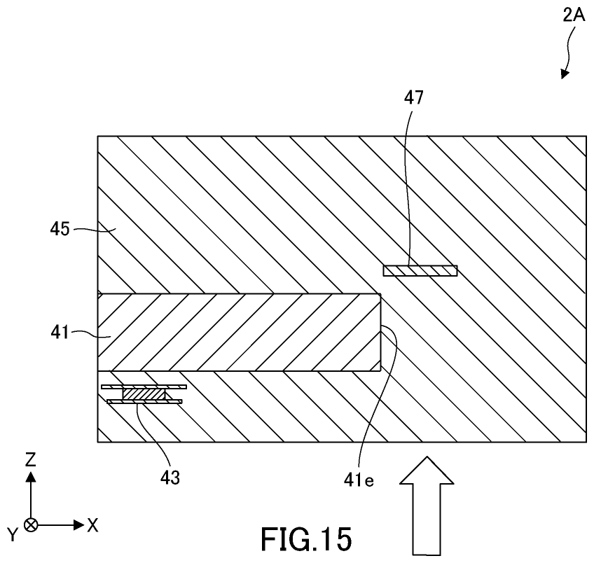

The second embodiment of the present disclosure will be described below. FIG. 13 is a conceptual diagram of the optical receiving device 2A(2) according to the second embodiment. FIGS. 14 and 15 are XZ cross-sectional views of the optical receiving device 2A.

As schematically shown in FIG. 13, the optical receiving device 2A according to the second embodiment includes a first receiving-side waveguide 40, a second receiving-side waveguide 41, a first light detection element 42, a second light detection element 43, and a cladding 45.

The first and second receiving-side waveguides 40, 41 and the first and second light detection elements 42, 43 are formed in the cladding 45. The cladding 45 is, for example, SiO₂, Al₂O₃, MgF₂, La₂O₃, ZnO, HfO₂, MgO, Y₂O₃, CaF₂, In₂O₃,, or a mixture thereof.

The first and second receiving-side waveguides 40, 41 are structures that form a path along which light propagates, similar to the waveguide 28 in the first embodiment. In this embodiment, it is assumed that light with a wavelength of, for example, 405 nm to 1600 nm is incident on the first and second receiving-side waveguides 40, 41.

The cladding 45 covers the periphery of the first and second receiving-side waveguides 40, 41. The light propagates through the first and second receiving-side waveguides 40, 41 while being totally reflected due to the difference in refractive index between the first and second receiving-side waveguides 40, 41 and the cladding 45. The first receiving-side waveguide 40 and the second receiving-side waveguide 41 are formed on the same plane within the cladding 45.

The first receiving-side waveguide 40 is optically coupled to a waveguide of an external optical circuit, and light from the external optical circuit is incident on the end 40e of the first receiving-side waveguide 40.

As shown in FIG. 14, the optical receiving device 2A has a reflector 46 that reflects light incident from above or below the cladding 45 and makes it incident on the second receiving-side waveguide 41. That is, light that is incident from above or below the cladding 45 and reflected by the reflector 46 is incident on the end 41e of the second receiving-side waveguide 41.

In the optical transmission apparatus 4 described later, when the optical receiving device 2A is located above the optical transmission device 1, the reflector 46 reflects the light from the splitter 19 of the optical transmission device 1 that enters from below the cladding 45. Conversely, when the optical receiving device 2A is located below the optical transmission device 1, the reflector 46 reflects the light from the splitter 19 of the optical transmission device 1 that enters from above the cladding 45. The reflector 46 is, for example, a mirror. The reflector 46 is, for example, inside the cladding 45.

In other words, the reflector 46 is located in a position where it can reflect the light split by the splitter 19 of the optical transmission device 1 and make the light reflected by the reflector 46 enter the second receiving-side waveguide 41.

The reflecting surface 46A of the reflector 46 is inclined with respect to the YZ plane. FIG. 14 shows an example in which the reflecting surface 46A is inclined in the-X direction with respect to the YZ plane when light is incident from below the cladding 45, but when light is incident from above the cladding 45, the reflecting surface 46A may be inclined in the +X direction with respect to the YZ plane.

Alternatively, as shown in FIG. 15, the optical receiving device 2A may have a reflector 47 that is a meta-mirror having a meta-diffraction grating instead of the reflector 46. By having the reflector 47 made of a meta-mirror, the optical receiving device 2A can control the wavelength of light incident on the second receiving-side waveguide 41.

So far, an example has been shown in which one reflector (reflectors 46, 47) is provided near the second receiving-side waveguide 41, but the number of reflectors provided near the second receiving-side waveguide 41 may be two or more.

The first and second receiving-side waveguides 40, 41 include, for example, SiO₂, SiNₓ (Si₃N₄), AlN, or Al₂O₃. The cladding 45 is, for example, SiO₂, Al₂O₃, MgF₂, La₂O₃, ZnO, HfO₂, MgO, Y₂O₃, CaF₂, In₂O₃, or a mixture thereof. The materials of the first and second receiving-side waveguides 40, 41 and the cladding 45 are not limited to this example. For example, the first and second receiving-side waveguides 40, 41 may be silicon or silicon oxide to which germanium oxide has been added, and the cladding 45 may be silicon oxide. Also, for example, the first and second receiving-side waveguides 40, 41 may be tantalum oxide (Ta₂O₅), and the cladding 45 may be silicon oxide or aluminum oxide.

The first and second light detection elements 42, 43 may be located in the same layer as the first and second receiving-side waveguides 40, 41 in the Z direction, or may be located in different layers.

The second light detection element 43 receives light propagating through the second receiving-side waveguide 41 and converts it into an electrical signal. For example, the second light detection element 43 is disposed in a position within the cladding 45 where it can receive leakage light from the second receiving-side waveguide 41.

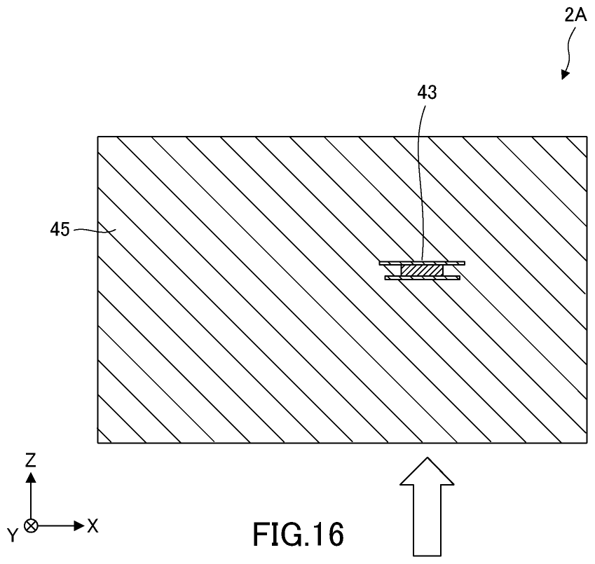

The second receiving-side waveguide 41 may be omitted. In this case, the second light detection element 43 may be disposed in a position where it can directly receive light incident from above or below the cladding 45 and convert it into an electrical signal, as shown in FIG. 16.

The first light detection element 42 receives light that is incident from an external optical circuit and propagates through the first receiving-side waveguide 40, and converts it into an electrical signal. For example, the first light detection element 42 is disposed in a position in the cladding 45 where it can receive the leakage light from the first receiving-side waveguide 40.

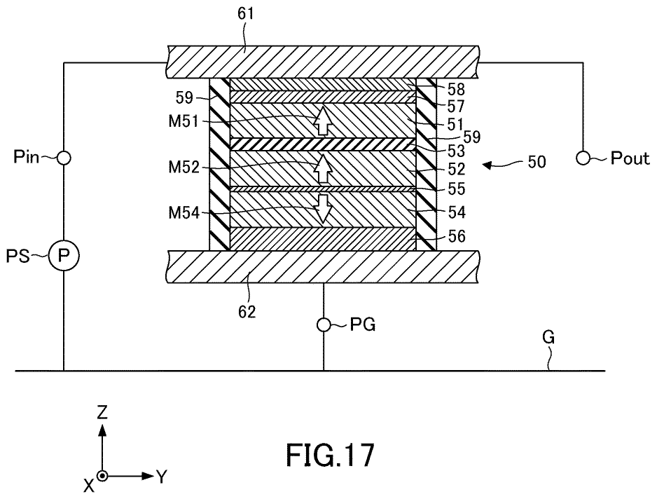

The first and second light detection elements 42, 43 have a magnetic element 50 that generates a voltage when irradiated with light, as shown in FIG. 17. When the state of the irradiated light changes, the resistance value of the magnetic element 50 in the Z direction changes according to the change in the state of the light. When the state of the light irradiated to the magnetic element 50 changes, the output voltage from the magnetic element 50 changes according to the change in the state of the light. Therefore, the magnetic element 50 functions as a light detection element for monitoring the intensity of the light propagating through the first and second receiving-side waveguides 40, 41.

The configuration of the magnetic element 50 will be described below with reference to FIG. 17. FIG. 17 is a YZ cross-sectional view of the magnetic element 50. In FIG. 17, the magnetizations M51, M52, and M54 in the state (initial state) of the first ferromagnetic layer 51, the second ferromagnetic layer 52, and the third ferromagnetic layer 54 are indicated by arrows.

As shown in FIG. 17, the magnetic element 50 has at least the first ferromagnetic layer 51, the second ferromagnetic layer 52, and the spacer layer 53. In FIG. 17, the second ferromagnetic layer 52, the spacer layer 53, and the first ferromagnetic layer 51 are stacked in this order toward the positive Z direction to form a stacked body. The upper surface of the spacer layer 53 is in contact with the lower surface of the first ferromagnetic layer 51. The lower surface of the spacer layer 53 is in contact with the upper surface of the second ferromagnetic layer 52. In this specification, the stacking direction of the magnetic element 50 means the stacking direction of the second ferromagnetic layer 52, the spacer layer 53, and the first ferromagnetic layer 51. In FIG. 17, the stacking direction of the magnetic element 50 coincides with the Z direction.

In the magnetic element 50, the resistance value when a current is passed in the stacking direction changes according to the relative change between the state of magnetization M51 of the first ferromagnetic layer 51 and the state of magnetization M52 of the second ferromagnetic layer 52.

The stacked body constituting the magnetic element 50 includes a third ferromagnetic layer 54, a magnetic coupling layer 55, an underlayer 56, a perpendicular magnetization induction layer 57, a cap layer 58, and a sidewall insulating layer 59, and may further include other layers as necessary. The maximum width of the magnetic element 50 in a plan view from the stacking direction is, for example, 10 nm to 2000 nm.

The first ferromagnetic layer 51 is a light detection layer in which the state of magnetization M51 changes when light is irradiated from the outside. The first ferromagnetic layer 51 is also called a magnetization free layer. The magnetization free layer is a layer containing a magnetic material whose magnetization state changes when energy from the outside is applied. The external energy applied to the first ferromagnetic layer 51 is, for example, light irradiated from the outside, a current flowing in the stacking direction of the magnetic element 50, an external magnetic field, etc. The state of magnetization M51 of the first ferromagnetic layer 51 changes depending on the intensity of the light irradiated to the first ferromagnetic layer 51.

The first ferromagnetic layer 51 contains a ferromagnetic material. The first ferromagnetic layer 51 contains at least one of magnetic elements such as Co, Fe, or Ni. The first ferromagnetic layer 51 may contain non-magnetic elements such as B, Mg, Hf, and Gd in addition to the magnetic elements as described above. The first ferromagnetic layer 51 may be, for example, an alloy containing a magnetic element and a non-magnetic element. The first ferromagnetic layer 51 may be composed of multiple layers. The first ferromagnetic layer 51 may be, for example, a CoFeB alloy, a laminate in which a CoFeB alloy layer is sandwiched between Fe layers, or a laminate in which a CoFeB alloy layer is sandwiched between CoFe layers.

The first ferromagnetic layer 51 may be an in-plane magnetized film having an easy axis of magnetization in the in-plane direction, or a perpendicular magnetized film having an easy axis of magnetization in the direction perpendicular to the film plane. The in-plane direction is parallel to the XY plane, and the direction perpendicular to the film plane is the Z direction.

The film thickness of the first ferromagnetic layer 51 is, for example, 1.0 nm to 5.0 nm, and preferably 1.0 nm to 2.0 nm. When the thickness of the first ferromagnetic layer 51 is thicker than 2.0 nm, an insertion layer made of, for example, Mo or W may be provided in the first ferromagnetic layer 51. For example, the first ferromagnetic layer 51 may be a laminate in which a ferromagnetic layer, an insertion layer, and a ferromagnetic layer are stacked in this order. The perpendicular magnetic anisotropy of the entire first ferromagnetic layer 51 is increased by the interfacial magnetic anisotropy at the interface between the insertion layer and the ferromagnetic layer. The thickness of the insertion layer is, for example, 0.1 nm to 0.6 nm.

The second ferromagnetic layer 52 is a magnetization fixed layer. The magnetization fixed layer is a layer made of a magnetic material in which the state of magnetization M52 is less likely to change when external energy is applied than the magnetization free layer.

When external energy is applied, the direction and strength of magnetization M52 of the second ferromagnetic layer 52, which is the magnetization fixed layer, is less likely to change than the first ferromagnetic layer 51, which is the magnetization free layer. The coercive force of the second ferromagnetic layer 52 is, for example, greater than that of the first ferromagnetic layer 51. The second ferromagnetic layer 52 has an easy axis of magnetization in the same direction as the first ferromagnetic layer 51. The second ferromagnetic layer 52 may be an in-plane magnetized film or a perpendicular magnetized film.

The second ferromagnetic layer 52 may be made of the same material as the first ferromagnetic layer 51. The second ferromagnetic layer 52 may be a laminate of, for example, Co with a thickness of 0.4 nm to 1.0 nm, Mo with a thickness of 0.1 nm to 0.5 nm, CoFeB alloy with a thickness of 0.3 nm to 1.0 nm, and Fe with a thickness of 0.3 nm to 1.0 nm, stacked in this order.

The magnetization M52 of the second ferromagnetic layer 52 may be fixed by magnetic coupling with the third ferromagnetic layer 54 through the magnetic coupling layer 55. In this case, the combination of the second ferromagnetic layer 52, the magnetic coupling layer 55, and the third ferromagnetic layer 54 may be referred to as a magnetization fixed layer.

The third ferromagnetic layer 54 is magnetically coupled with the second ferromagnetic layer 52. The magnetic coupling is, for example, an antiferromagnetic coupling, and occurs due to RKKY interaction. The material constituting the third ferromagnetic layer 54 may be the same as that of the first ferromagnetic layer 51. The material of the magnetic coupling layer 55 may be, for example, Ru, Ir, or the like.

The spacer layer 53 is a non-magnetic layer disposed between the first ferromagnetic layer 51 and the second ferromagnetic layer 52. The spacer layer 53 is sandwiched between the first ferromagnetic layer 51 and the second ferromagnetic layer 52. The spacer layer 53 is composed of a layer made of a conductor, an insulator, or a semiconductor, or a layer containing a current-carrying point made of a conductor in an insulator. The thickness of the spacer layer 53 can be adjusted according to the orientation of the magnetization M51 of the first ferromagnetic layer 51 and the magnetization M52 of the second ferromagnetic layer 52 in the initial state.

For example, when the spacer layer 53 is made of an insulator, the magnetic element 50 has a magnetic tunnel junction made of the first ferromagnetic layer 51, the spacer layer 53, and the second ferromagnetic layer 52. Such an element is called an MTJ (Magnetic Tunnel Junction) element. In this case, the magnetic element 50 can exhibit a TMR (Tunnel Magnetoresistance) effect. When the spacer layer 53 is made of a non-magnetic conductive material, the magnetic element 50 can exhibit a GMR (Giant Magnetoresistance) effect. Such an element is called a GMR element. The magnetic element 50 may be called an MTJ element, a GMR element, or the like, depending on the material of the spacer layer 53, but is generally called a magnetoresistance effect element.

When the spacer layer 53 is made of an insulating material, the spacer layer 53 may be made of a material containing aluminum oxide, magnesium oxide, titanium oxide, silicon oxide, or the like. The spacer layer 53 may contain elements such as Al, B, Si, and Mg, or magnetic elements such as Co, Fe, and Ni, in addition to these insulating materials. By adjusting the thickness of the spacer layer 53 so that a high TMR effect is exhibited between the first ferromagnetic layer 51 and the second ferromagnetic layer 52, a high magnetoresistance change rate can be obtained. In order to efficiently realize the TMR effect, the thickness of the spacer layer 53 may be about 0.5 nm to 5.0 nm, or even about 1.0 nm to 2.5 nm.

When the spacer layer 53 is made of a non-magnetic conductive material, a conductive material such as Cu, Ag, Au, or Ru can be used. In order to efficiently realize the GMR effect, the thickness of the spacer layer 53 may be about 0.5 nm to 5.0 nm, or even about 2.0 nm to 3.0 nm.

When the spacer layer 53 is made of a non-magnetic semiconductor material, a metal material such as zinc oxide, indium oxide, tin oxide, germanium oxide, gallium oxide, or ITO can be used for the spacer layer 53. In this case, the thickness of the spacer layer 53 may be about 1.0 nm to 4.0 nm.

When a layer including a current-carrying point formed by a conductor in a nonmagnetic insulator is used as the spacer layer 53, a structure including a current-carrying point formed by a nonmagnetic conductor such as Cu, Au, or Al in a nonmagnetic insulator formed by aluminum oxide or magnesium oxide may be used. The conductor may also be formed by a magnetic element such as Co, Fe, or Ni. In this case, the thickness of the spacer layer 53 may be about 1.0 nm to 2.5 nm. The current-carrying point may be, for example, a columnar body. The diameter of the columnar body when viewed from a direction perpendicular to the film surface may be 1.0 nm to 5.0 nm.

The underlayer 56 is disposed between the third ferromagnetic layer 54 and the lower electrode 62. The underlayer 56 is a seed layer or a buffer layer. The seed layer is a layer that enhances the crystallinity of the layer stacked on the seed layer. The seed layer includes, for example, Pt, Ru, Hf, Zr, and NiFeCr. The seed layer has a thickness of, for example, 1.0 nm to 5.0 nm. The buffer layer is a layer that relieves lattice mismatch between different crystals. The buffer layer includes, for example, Ta, Ti, W, Zr, Hf, or nitrides of these elements. The buffer layer has a thickness of, for example, 1.0 nm to 5.0 nm.

The cap layer 58 is provided between the first ferromagnetic layer 51 and the upper electrode 61. The cap layer 58 prevents damage to the lower layer during the process and enhances the crystallinity of the lower layer during annealing. The cap layer 58 has a thickness of, for example, 3.0 nm or less so that the first ferromagnetic layer 51 is irradiated with sufficient light. The cap layer 58 is, for example, MgO, W, Mo, Ru, Ta, Cu, Cr, or a laminated film of these elements.

The perpendicular magnetization induced layer 57 is formed when the first ferromagnetic layer 51 is a perpendicular magnetization film. The perpendicular magnetization induced layer 57 is laminated on the first ferromagnetic layer 51. The perpendicular magnetization induced layer 57 induces perpendicular magnetic anisotropy in the first ferromagnetic layer 51. The perpendicular magnetization induced layer 57 is, for example, magnesium oxide, W, Ta, Mo, etc. When the perpendicular magnetization induced layer 57 is magnesium oxide, it is preferable that the magnesium oxide has oxygen deficiency in order to increase the conductivity. The film thickness of the perpendicular magnetization induced layer 57 is, for example, 0.5 nm to 2.0 nm.

The sidewall insulating layer 59 covers the periphery of the laminate including the first ferromagnetic layer 51 and the second ferromagnetic layer 52. The sidewall insulating layer 59 is, for example, an oxide, nitride, or oxynitride of Si, Al, or Mg.

FIG. 17 schematically shows the magnetic element 50, an upper electrode 61 in contact with the upper surface of the magnetic element 50, a lower electrode 62 in contact with the lower surface of the magnetic element 50, and a circuit connected to the upper electrode 61 and the lower electrode 62.

The upper electrode 61 is connected to, for example, the input terminal Pin and the output terminal Pout, and the lower electrode 62 is connected to, for example, a reference potential through the reference potential terminal PG. The reference potential may be provided outside the optical receiving device 2A. The reference potential may be ground G or may be other than ground G.

The input terminal Pin is connected to a power supply PS. The power supply PS may be a current source or a voltage source. The power supply PS may be mounted on the optical receiving device 2A, or may be provided outside the optical receiving device 2A.

When the input terminal Pin is connected to the power supply PS as a current source, the output terminal Pout outputs the resistance value of the magnetic element 50 in the stacking direction as a voltage. When the input terminal Pin is connected to the power supply PS as a voltage source, the output terminal Pout outputs the resistance value of the magnetic element 50 in the stacking direction as a current. If there is no need to apply a current or voltage to the magnetic element 50 from the outside, the input terminal Pin and the power supply PS do not need to be provided.

The upper electrode 61 and the lower electrode 62 contain a conductive material. The upper electrode 61 and the lower electrode 62 are made of, for example, a plate-shaped member containing a conductive material, and are arranged opposite to each other with the magnetic element 50 sandwiched therebetween. The upper electrode 61 is connected to the first surface of the magnetic element 50. The lower electrode 62 is connected to the second surface of the magnetic element 50. In the following, the first surface of the magnetic element 50 located on the upper electrode 61 side may be referred to as the upper surface, and the second surface of the magnetic element 50 located on the lower electrode 62 side may be referred to as the lower surface. The upper and lower surfaces of the magnetic element 50 face each other in the stacking direction of the magnetic element 50.

As the material of the upper electrode 61 and the lower electrode 62, for example, metals such as Cu, Al, Au, or Ru can be used. Ta or Ti may be stacked above and below these metals. In addition, as the upper electrode 61 and the lower electrode 62, a stacked film of Cu and Ta, a stacked film of Ta, Cu, and Ti, a stacked film of Ta, Cu, and TaN, or TiN or TaN may be used.

The upper electrode 61 and the lower electrode 62 may be optically transparent to the wavelength range of light irradiated to the magnetic element 50. For example, the upper electrode 61 and the lower electrode 62 may be transparent electrodes containing transparent electrode materials such as indium tin oxide (ITO), indium zinc oxide (IZO), zinc oxide (ZnO), and indium gallium zinc oxide (IGZO). The upper electrode 61 and the lower electrode 62 may be configured to have a plurality of columnar metals in these transparent electrode materials.

So far, examples have been disclosed in which the first and second light detection elements 42 and 43 each have one magnetic element 50, but the first and second light detection elements 42 and 43 may have a plurality of magnetic elements 50.

If the first and second light detection elements 42 and 43 have a plurality of magnetic elements 50, the outputs from the respective magnetic elements 50 that behave in the same way with respect to light can be combined and output from the optical receiving device 2A. As a result, noise in the output signal of the optical receiving device 2A can be suppressed, and the SN ratio of the optical receiving device 2A can be increased.

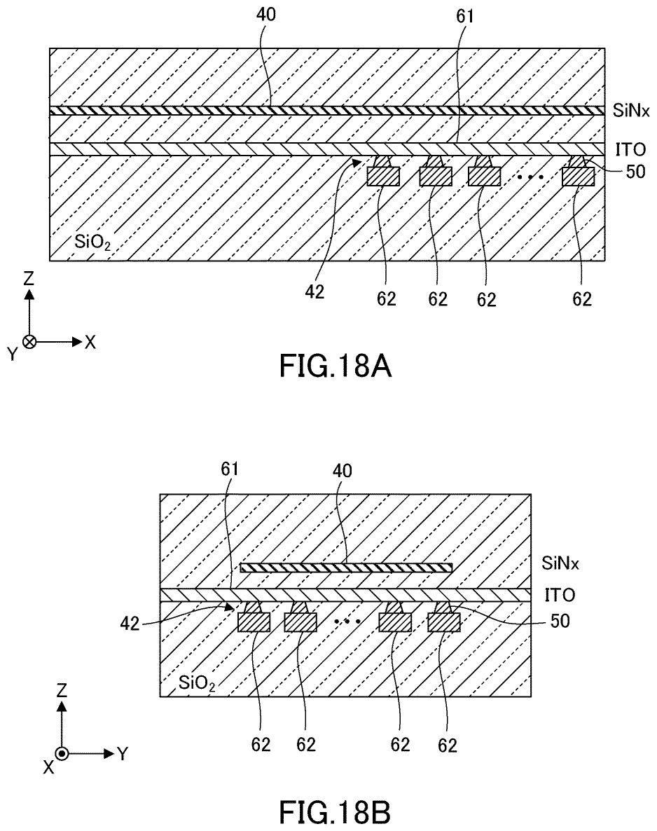

FIGS. 18A and 18B are cross-sectional views showing an example of an array arrangement of a plurality of magnetic elements 50 in the first light detection element 42. As shown in FIG. 18A, the magnetic elements 50 may be connected in series or parallel along the direction in which the first receiving-side waveguide 40 extends (X direction). FIG. 18A shows an example in which the magnetic elements 50 are connected in parallel by the upper electrode 61 and the lower electrode 62.

Furthermore, as shown in FIG. 18B, the magnetic elements 50 in the first light detection element 42 may be connected in series or parallel along the width direction (Y direction) of the first receiving-side waveguide 40. FIG. 18B shows an example in which each magnetic element 50 is connected in parallel by an upper electrode 61 and a lower electrode 62.

In the example shown in FIGS. 18A and 18B, since the first light detection element 42 is disposed below the first receiving-side waveguide 40, it is preferable that the upper electrode 61 is a transparent electrode made of ITO or the like. The first light detection element 42 may be disposed above the first receiving-side waveguide 40, in which case it is preferable that the lower electrode 62 is a transparent electrode made of ITO or the like.

Similarly to the first light detection element 42, the second light detection element 43 may also have a plurality of magnetic elements 50 arranged in a series or parallel array.

The optical receiving device 2A configured in this manner receives an optical signal incident on the first receiving-side waveguide and converts it into an electrical signal, and can monitor the intensity of light incident from above or below the cladding 45.

So far, an example of the present disclosure has been described using the second embodiment as an example, but the present disclosure is not limited to this embodiment.

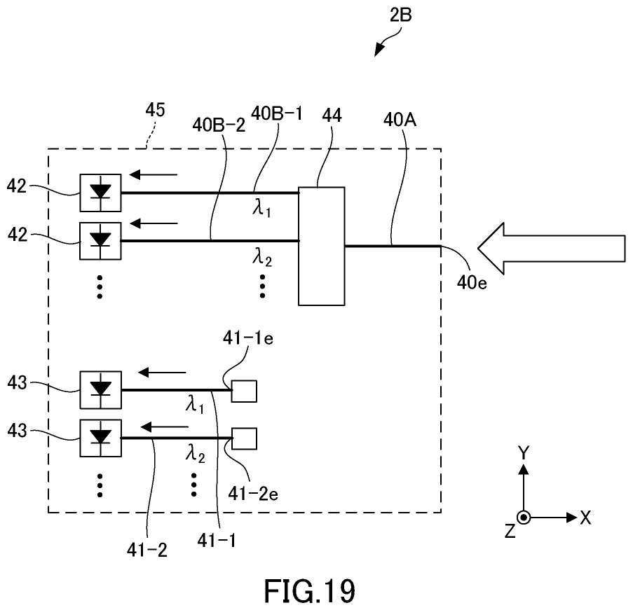

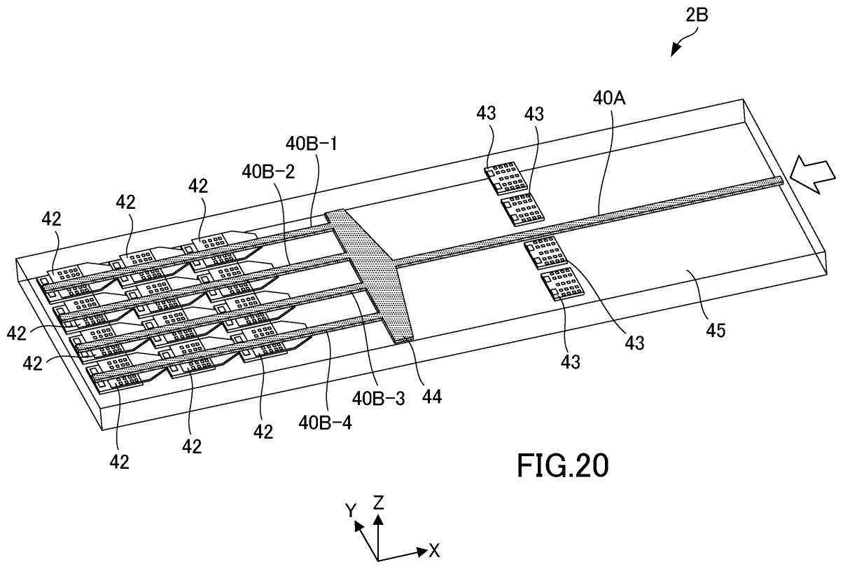

For example, FIG. 19 is a conceptual diagram of an optical receiving device 2B(2) according to the first modified example. FIG. 20 is a perspective view of the optical receiving device 2B(2).

The optical receiving device 2B includes a first receiving-side waveguide 40, a plurality of second receiving-side waveguides 41 (41-1, . . . , 41-N), a plurality of first light detection elements 42, a plurality of second light detection elements 43, a demultiplexer 44, and a cladding 45. Here, FIG. 20 shows an example in which the plurality of second receiving-side waveguides 41 are omitted. A wavelength division multiplexed optical signal is input from an external optical circuit to the first receiving-side waveguide 40 of the optical receiving device 2B.

The demultiplexer 44 splits the wavelength division multiplexed light input from the external optical circuit to the first receiving-side waveguide 40 into a plurality of different wavelengths λ₁, . . . , λ_{N} (N is an integer of 2 or more). The demultiplexer 44 includes, for example, a multimode interference waveguide (MMI), an arrayed waveguide grating (AWG), or a ring resonator array.

The first receiving-side waveguide 40 has an input-side waveguide 40A and a number of branching waveguides 40B (40B-1, . . . , 40B-N) that propagate the light of the different wavelengths λ₁, . . . , λ_{N} split by the demultiplexer 44. The first receiving-side waveguide 40 is covered with a cladding 45.

The input-side waveguide 40A is optically coupled to an external optical circuit, and light from the external optical circuit is incident on the end 40e of the input-side waveguide 40A.

The second receiving-side waveguides 41 are covered by the cladding 45, as is the first receiving-side waveguide 40. The second receiving-side waveguides 41 are optically coupled to light incident from above or below the cladding 45. The reflector 46 or the reflector 47 is disposed in the vicinity of each second receiving-side waveguide 41 in the cladding 45. That is, the light incident from above or below the cladding 45 and reflected by the reflector 46 or the reflector 47 enters the end 41e (41-1e, . . . , 41-Ne) of each second receiving-side waveguide 41.

With this configuration, for example, when the optical receiving device 2B is located on the upper layer of the optical transmission device 1, light with wavelengths λ₁, . . . , λ_{N} propagating through each branching waveguide 16 of the optical transmission device 1 is incident on each second receiving-side waveguide 41.

The first light detection elements 42 are arranged at positions where they can receive light incident from an external optical circuit and propagate through each branching waveguide 40B and convert it into an electrical signal. The second light detection elements 43 are arranged at positions where they can receive light propagating through each second receiving-side waveguide 41 and convert it into an electrical signal. Alternatively, the second light detection elements 43 may be arranged at positions where they can directly receive light with wavelengths λ₁, . . . , λ_{N} incident from above or below the cladding 45 and convert it into an electrical signal.

The optical receiving device 2B thus configured receives wavelength division multiplexed optical signals, converts them into electrical signals for each wavelength division multiplexing channel of wavelengths λ₁, . . . , λ_{N}, and monitors the intensity of the light of wavelengths λ₁, . . . , λ_{N} incident from above or below the cladding 45.

Furthermore, as shown in FIG. 20, a plurality of first light detection elements 42 may be arranged in the vicinity of each branching waveguide 40B along the direction in which each branching waveguide 40B extends (X direction). In this case, the SN ratio of the optical receiving device 2A can be further increased.

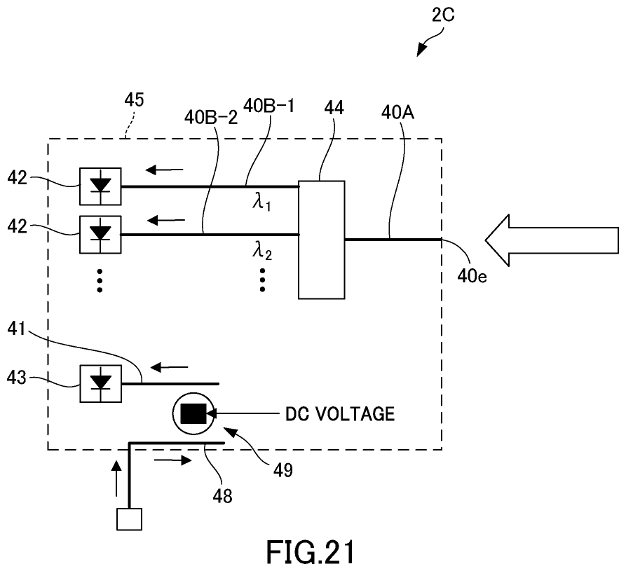

FIG. 21 is a conceptual diagram of an optical receiving device 2C (2) according to a second modified example. The optical receiving device 2C includes a first receiving-side waveguide 40, a second receiving-side waveguide 41, a third receiving-side waveguide 48, a plurality of first light detection elements 42, a second light detection element 43, a demultiplexer 44, an optical filter 49, and a cladding 45. Similarly to the optical receiving device 2B, a wavelength division multiplexed optical signal is input to the first receiving-side waveguide 40 of the optical receiving device 2C from an external optical circuit.

The third receiving-side waveguide 48 is a waveguide that propagates light incident from above or below the cladding 45 to the second receiving-side waveguide 41.

The optical filter 49 is provided between the second receiving-side waveguide 41 and the third receiving-side waveguide 48, and is adapted to select the wavelength of light incident from the second receiving-side waveguide 41 to the second light detection element 43. The optical filter 49 is, for example, a ring resonator with a variable resonance frequency, and is adapted to output light of a wavelength corresponding to the resonance frequency to the second receiving-side waveguide 41. The resonance frequency can be electrically controlled by changing the DC voltage applied to the ring resonator.

For example, the optical filter 49 can select light of any of the wavelengths λ₁, . . . , λ_{N} from the wavelength division multiplexed light branched by the brancher 19 provided in the output-side waveguide 20 of the optical transmission device 1, and input the selected light to the second receiving-side waveguide 41.

Furthermore, the optical receiving device 2C provided with such an optical filter 49 leads to the fact that the number of second light detection elements 43 required is only one, thereby making it possible to reduce the overall size of the device.

As described above, the optical receiving device 2According to this embodiment can be applied to a three-dimensional optical device structure, and for example, when the optical transmission device 1 is provided in a lower layer, the intensity of the output light from the optical transmission device 1 can be monitored. In addition, the optical receiving device 2 can receive an optical signal from an external optical circuit and convert it into an electrical signal. In addition, the optical receiving device 2 becomes an integrated optical device equipped with a waveguide and a light detection element on approximately the same plane in the cladding 45, and thus can be made compact and highly dense.

The third embodiment of the present disclosure will be described below. Here, the same names or symbols are used for configurations similar to those of the first or second embodiment, and descriptions will be omitted as appropriate. In addition, descriptions of operations similar to those of the first or second embodiment will be omitted as appropriate.

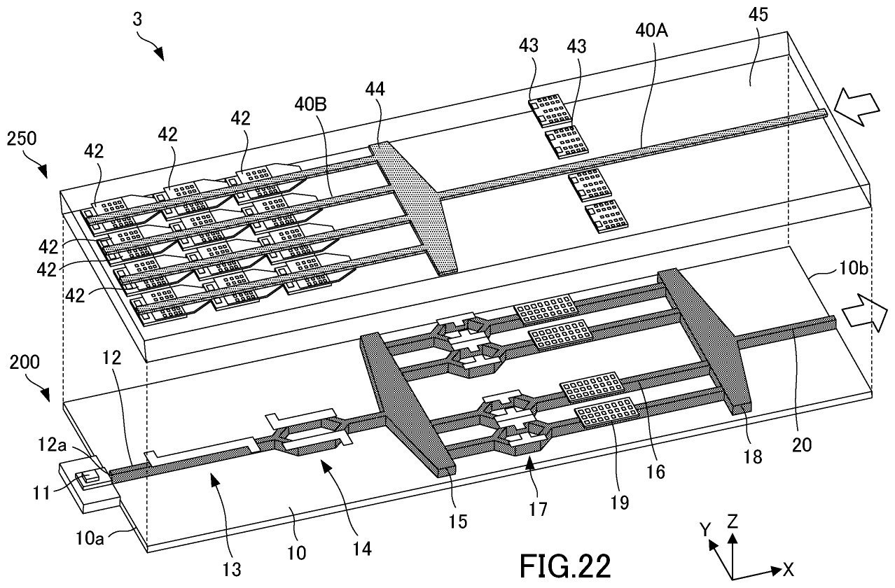

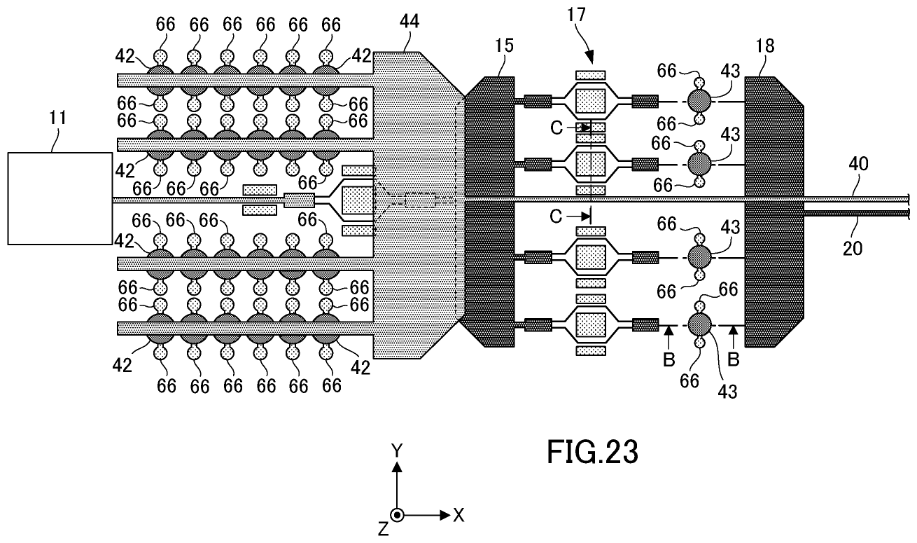

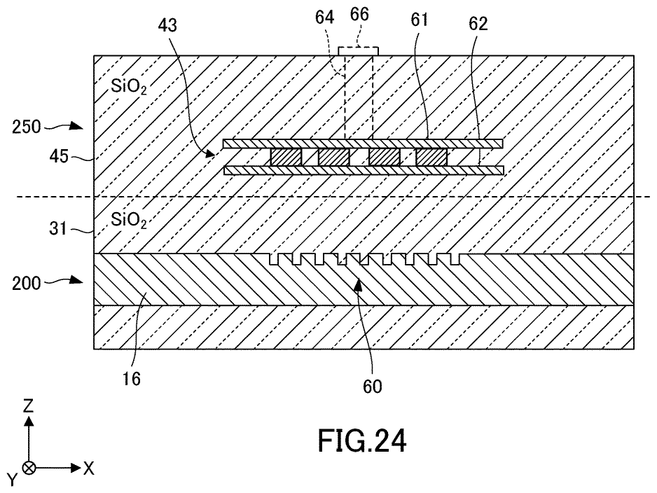

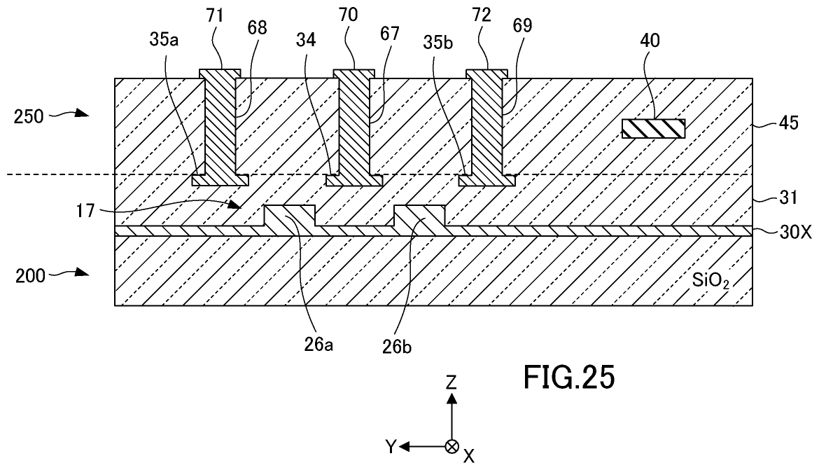

FIG. 22 is an exploded perspective view of the optical transmission/reception device 3 according to the third embodiment. FIG. 23 is a plan view perspective view of the optical transmission/reception device 3. FIG. 24 is a cross-sectional view taken along line B-B in FIG. 23. FIG. 25 is a cross-sectional view taken along line C-C in FIG. 23.

As shown in FIGS. 22 to 25, the optical transmission/reception device 3 is a device in which an optical transmitting layer 200 made of the optical transmission device 1 according to the first embodiment and an optical receiving layer 250 made of the optical receiving device 2 according to the second embodiment are coupled in the vertical direction.

FIG. 24 shows an example of the structure of the optical coupling portion between the branching waveguide 16 of the optical transmitting layer 200 and the second light detection element 43 of the optical receiving layer 250. The cladding 31 of the optical transmitting layer 200 and the cladding 45 of the optical receiving layer 250 are integrally formed of a common material such as SiO₂.

A splitter 19 such as a diffraction grating 60 provided on the branching waveguide 16 splits a part of the modulated light beam of wavelengths λ₁, . . . , λ_{N} propagating in the horizontal direction (X direction) through each branching waveguide 16 in the vertical direction (Z direction). The branched light beam split by the splitter 19 is received by the second light detection element 43 and converted into an electrical signal for monitoring.

When the splitter 19 is provided on the output-side waveguide 20, a part of the wavelength division multiplexed light is split in the vertical direction (Z direction), and the optical filter 49 selects light of one of the wavelengths λ₁, . . . , λ_{N}, and the light is received by the second light detection element 43.

In the example of FIG. 24, the second light detection element 43 is placed directly above the diffraction grating 60. The SiO₂ of the cladding 31, 45 is transparent to visible light, so that the light that travels vertically through the diffraction grating 60 passes through the SiO₂ and enters the second light detection element 43.

The upper electrodes 61 and lower electrodes 62 of the multiple second light detection elements 43 are each electrically connected to a via wiring 64.

The via wiring 64 connects the input/output terminal 66 to the upper electrode 61 or the lower electrode 62. The input/output terminal 66 is provided corresponding to the via wiring 64. Here, as an example, two via wirings 64 and two input/output terminals 66 are provided for one second light detection element 43. One of the input/output terminals 66 is electrically connected to the upper electrode 61, and a current or voltage is input and an electrical signal is output. The other end of the input/output terminal 66 is electrically connected to the lower electrode 62 and is connected to a reference potential. The input/output terminal 66 is exposed, for example, on the upper surface of the cladding 45 of the optical receiving layer 250.

Similarly to the second light detection element 43, the first light detection element 42 has one end of the input/output terminal 66 electrically connected to the upper electrode 61 through a via wiring, and a current or voltage is input and an electric signal is output. The other end of the input/output terminal 66 is electrically connected to the lower electrode 62 through a via wiring and is connected to a reference potential. The input/output terminal 66 is exposed, for example, on the upper surface of the cladding 45 of the optical receiving layer 250.

As shown in FIG. 25, the signal electrode 34 and the ground electrodes 35a and 35b of each intensity modulator 17 provided in the branching waveguide 16 are electrically connected to the via wirings 67, 68, and 69, respectively. Although the example in FIG. 25 illustrates a configuration in which the oxide film 30 is a-axis oriented, the present disclosure is not limited thereto, and the oxide film 30 may alternatively be c-axis oriented.

The via wiring 67 connects the signal input terminal 70 to one end 34i of the signal electrode 34. The via wirings 68, 69 connect the ground terminals 71, 72 to the ground electrodes 35a, 35b, respectively. The signal input terminal 70 receives an intensity modulation signal from the modulation signal source 22. The ground terminals 71, 72 are connected to a reference potential. The signal input terminal 70 and the ground terminals 71, 72 are exposed, for example, on the upper surface of the cladding 45 of the light receiving layer 250.

Similarly, for the intensity modulator 14 constituting the optical frequency comb generator 25 in the optical transmission layer 200, the signal electrode 34 and the ground electrodes 35a and 35b are electrically connected, through the via wiring, to a signal input terminal and a ground terminal (not shown) exposed on the upper surface of the cladding 45 of the optical receiving layer 250. Similarly, for the phase modulator 13 constituting the optical frequency comb generator 25, the signal electrode 32 and the ground electrode 33 are electrically connected, through the via wiring, to a signal input terminal and a ground terminal (not shown) exposed on the upper surface of the cladding 45 of the optical receiving layer 250.

As described above, the optical transmission/reception device 3 according to this embodiment has a two-layer structure in which the laser light source 11 and the first and second light detection elements 42, 43 are integrated into one device, and the optical transmission layer 200 including the laser light source 11 and the optical receiving layer 250 including the first and second light detection elements 42, 43 are optically coupled in the vertical direction. The optical transmission/reception device 3 can generate a wavelength division multiplexed optical signal from the optical transmission layer 200 and output it to an external optical circuit, and can receive a wavelength division multiplexed optical signal from the external optical circuit and convert it into an electrical signal.

The following describes the fourth embodiment of the present disclosure. Here, the same names or symbols are used for the same configurations as the first to third embodiments, and the description will be omitted as appropriate. Also, the description of the same operations as the first to third embodiments will be omitted as appropriate.

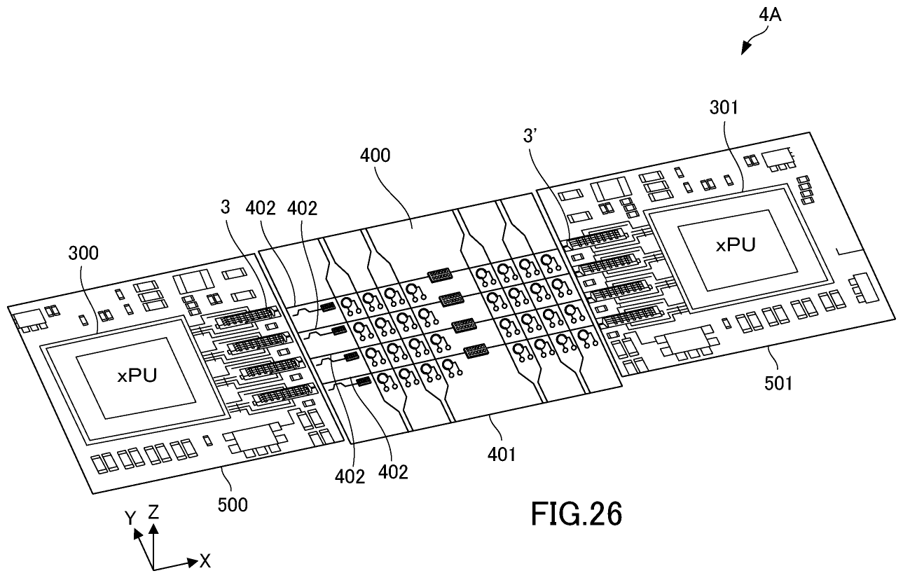

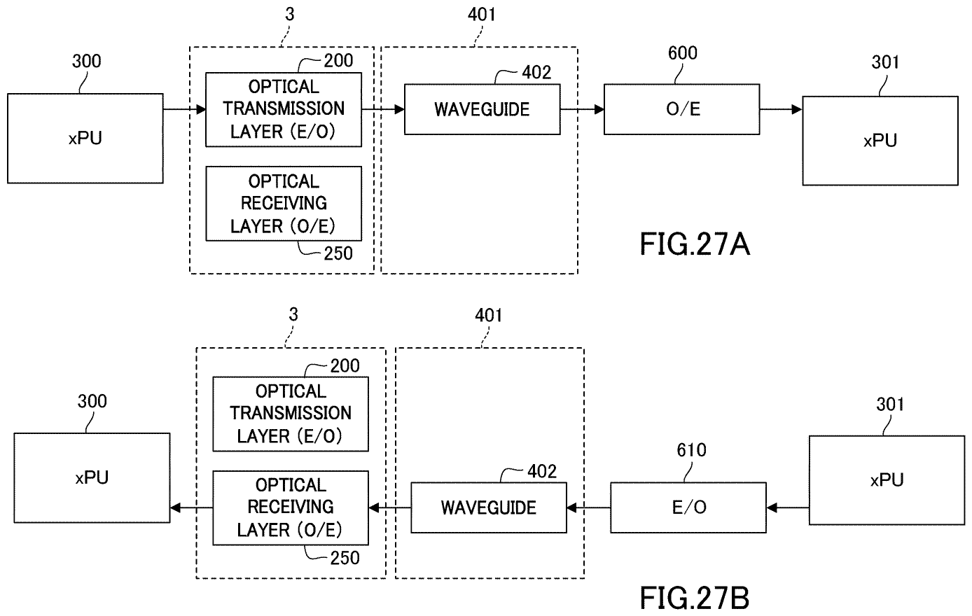

FIG. 26 is a perspective view of an optical transmission apparatus 4A (4) according to the fourth embodiment. FIGS. 27A and 27B are block diagrams of the optical transmission apparatus 4A.

The optical transmission apparatus 4A includes an optical transmission device 3 according to the third embodiment, semiconductor electronic circuits 300, 301, and an optical circuit board 400. The optical transmission device 3 and the semiconductor electronic circuit 300 are provided on an electronic circuit board 500. The semiconductor electronic circuit 301 is provided on an electronic circuit board 501.

The optical circuit board 400 is an example of an external optical circuit as seen from the optical transmission device 3, and connects the semiconductor electronic circuits 300, 301. The optical circuit board 400 has at least one optical circuit board layer 401. FIGS. 26, 27A and 27B show the configuration of the optical transmission apparatus 4A when the optical circuit board 400 has one optical circuit board layer 401.

The optical transmission/reception device 3 includes an optical transmission layer 200 that functions as an electrical-optical conversion circuit that converts an electrical signal output from the semiconductor electronic circuit 300 into an optical signal, and an optical receiving layer 250 that functions as an optical-electrical conversion circuit that converts an optical signal output from the optical circuit board 400 into an electrical signal.

The semiconductor electronic circuits 300 and 301 include integrated circuits such as a GPU and a CPU. The semiconductor electronic circuits 300 and 301 function as a modulation signal source 22 and output an intensity modulation signal for intensity modulating a plurality of demultiplexed light beams propagating through a plurality of branching waveguides 16 of the optical transmission layer 200.

That is, the intensity modulation signal from the semiconductor electronic circuit 300 is input to a plurality of intensity modulators 17 in the optical transmission layer 200. In addition, at least one of the output-side waveguide 20 of the optical transmission layer 200 and the first receiving-side waveguide 40 of the optical receiving layer 250 is optically coupled to an end face of the waveguide 402 of the optical circuit board layer 401.

FIG. 27A shows a configuration in which the output-side waveguide 20 of the optical transmission layer 200 is optically coupled to one end face of the waveguide 402 of the optical circuit board layer 401, and the other end face of the waveguide 402 of the optical circuit board layer 401 is optically coupled to an arbitrary photoelectric conversion circuit 600. That is, the electrical signal output from one semiconductor electronic circuit 300 is converted into a wavelength division multiplexed optical signal in the optical transmission layer 200, the optical signal output from the optical circuit board 400 is converted into an electrical signal in the optical-electrical conversion circuit 600, and is input to the other semiconductor electronic circuit 301.

FIG. 27B shows a configuration in which the first receiving-side waveguide 40 of the optical receiving layer 250 is optically coupled to one end face of the waveguide 402 of the optical circuit board layer 401, and the other end face of the waveguide 402 of the optical circuit board layer 401 is optically coupled to an arbitrary electrical-optical conversion circuit 610. That is, the electrical signal output from the other semiconductor electronic circuit 301 is converted into an optical signal in the electrical-optical conversion circuit 610, and the optical signal output from the optical circuit board 400 is converted into an electrical signal in the optical receiving layer 250, and is input to one semiconductor electronic circuit 300.

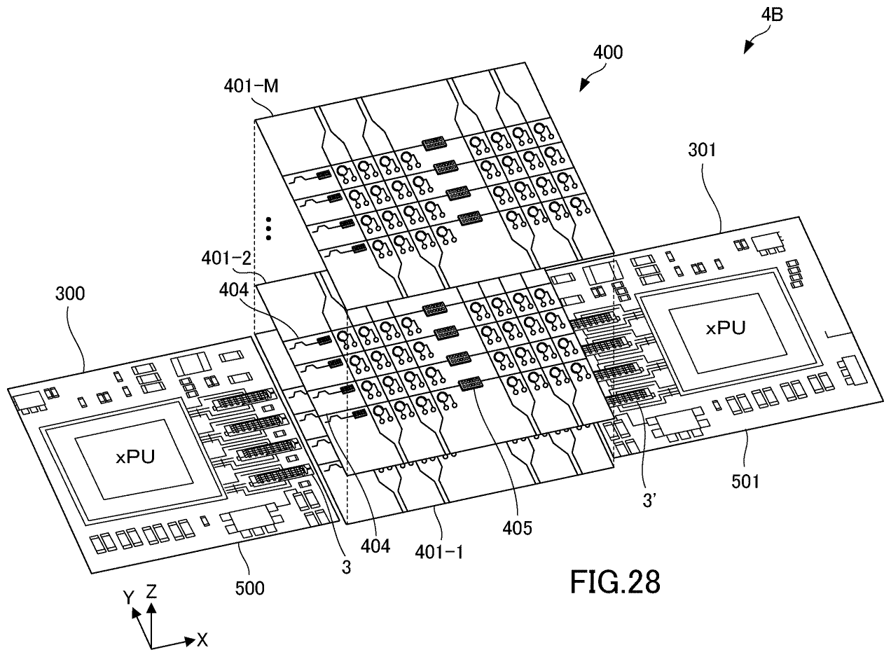

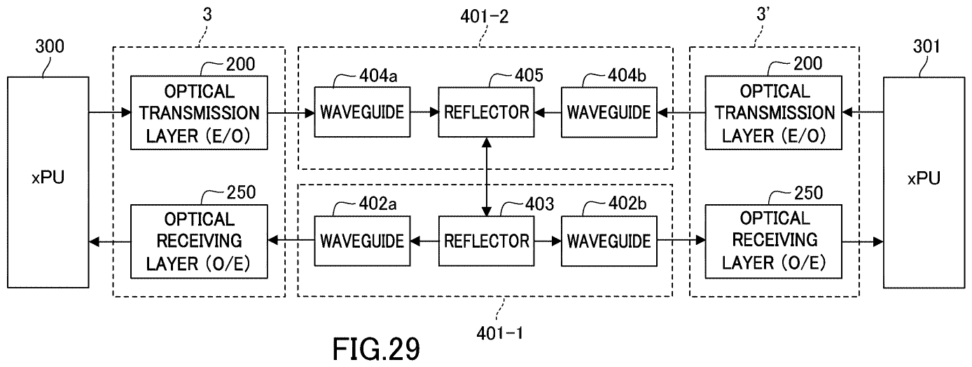

FIG. 28 is a perspective view of an optical transmission apparatus 4B (4), which is a modified example of the optical transmission apparatus 4A. In the optical transmission apparatus 4B, the optical circuit board 400 has a multilayer structure consisting of two or more optical circuit board layers 401 (401-1, . . . , 401-M) (M is an integer of 2 or more). FIG. 29 is a block diagram of the optical transmission apparatus 4B in which the optical circuit board 400 consists of two optical circuit board layers 401-1 and 401-2.

The optical circuit board layer 401-1 has a waveguide 402 (402a, 402b) and a reflector 403 provided in the middle of the waveguide 402. The optical circuit board layer 401-2 has a waveguide 404 (404a, 404b) and a reflector 405 provided in the middle of the waveguide 404. The waveguides 402, 404 are made of, for example, SiNₓ, LiNbO₃, or SiO₂.

The reflectors 403, 405 are either a diffraction grating, a meta-mirror, or a mirror, and the waveguide 402 formed in the optical circuit board layer 401-1 and the waveguide 404 formed in the optical circuit board layer 401-2 are optically coupled to each other. If the optical circuit board 400 has three or more optical circuit board layers 401, the waveguides of the optical circuit board layers 401 adjacent in the vertical direction (Z direction) are similarly optically coupled to each other.

In the optical transmission apparatus 4B, the output-side waveguide 20 of the optical transmission layer 200 is optically coupled to the end face of a waveguide 404a provided in the second layer, the optical circuit board layer 401-2 of the optical circuit board 400, and an end face of the waveguide 404b of the optical circuit board layer 401-2 is optically coupled to the output-side waveguide 20 of the optical transmission layer 200 of an optical transmission device 3′ having a configuration similar to that of the optical transmission device 3. The optical transmission device 3′ is provided on an electronic circuit board 501.

Furthermore, the first receiving-side waveguide 40 of the optical receiving layer 250 of the optical transmission/reception device 3 is optically coupled to the end face of the waveguide 402a of the first optical circuit board layer 401-1 of the optical circuit board 400, and the end face of the waveguide 402b of the optical circuit board layer 401-1 is optically coupled to the first receiving-side waveguide 40 of the optical receiving layer 250 of the optical transmission/reception device 3′.

As a result, the intensity modulation signal from the semiconductor electronic circuit 300 is input to the multiple intensity modulators 17 of the optical transmitting layer 200 of the optical transmission/reception device 3. The wavelength division multiplexed optical signal from the optical transmission layer 200 of the optical transmission/reception device 3 enters the waveguide 404a of the second optical circuit board layer 401-2, and then enters the waveguide 402b of the first optical circuit board layer 401-1 through the reflectors 405 and 403. The wavelength division multiplexed optical signal propagating through the waveguide 402b enters the first receiving-side waveguide 40 of the optical receiving layer 250 of the optical transmission/reception device 3′.

On the other hand, the intensity modulation signal from the semiconductor electronic circuit 301 is input to a plurality of intensity modulators 17 in the optical transmission layer 200 of the optical transmission device 3′. The wavelength division multiplexed optical signal from the optical transmission layer 200 of the optical transmission device 3′ is incident on the waveguide 404b of the second optical circuit board layer 401-2, and then incident on the waveguide 402a of the first optical circuit board layer 401-1 through the reflectors 405 and 403. The wavelength division multiplexed optical signal propagating through the waveguide 402a is incident on the first receiving-side waveguide 40 of the optical receiving layer 250 of the optical transmission device 3.

Furthermore, each optical circuit board layer 401 may include an optical functional element such as a ring resonator, a Mach-Zehnder type modulator, a splitter, or a multiplexer. This makes it possible for the optical circuit board 400 to be provided with functions of route selection, wavelength filtering, and intensity modulation.

As described above, the optical transmission apparatus 4 according to this embodiment can transmit and receive signals between the semiconductor electronic circuits 300, 301 through the optical circuit board 400. Furthermore, when the optical circuit board 400 has a multi-layer structure, the optical transmission apparatus 4 according to this embodiment can increase the integration density and improve the signal transmission density.

Although the disclosure has been described with respect to only a limited number of embodiments, those skilled in the art, having benefit of this disclosure, will appreciate that various other embodiments may be devised without departing from the spirit and scope of the present disclosure. Accordingly, the technical scope of the disclosed subject matter should be limited only by the attached claims.

### Description of Reference Numerals and Signs

1 Optical transmission device
2, 2A, 2B, 2C Optical receiving device
3 Optical transmission/reception device
4, 4A, 4B Optical transmission apparatus
10 Substrate
11 Laser light source
12 Input-side waveguide
13, 13X, 13Z Phase modulator
14, 14X, 14Z Intensity modulator
15 Demultiplexer
16 Branching waveguide
17 Intensity modulator
18 Multiplexer
19 Splitter
20 Output-side waveguide
21 RF signal source
22 Modulation signal source
25 Optical frequency comb generator
26 Mach-Zehnder type waveguide
30, 30X, 30Z Oxide film
31 Cladding
40 First receiving-side waveguide
41 Second receiving-side waveguide
42 First light detection element
43 Second light detection element
44 Demultiplexer
45 Cladding
46, 47 Reflector
48 Third receiving-side waveguide
49 Optical filter
50 Magnetic element
100 Optical transmission system
200 Optical transmission layer
250 Optical receiving layer
300, 301 Semiconductor electronic circuit
400 Optical circuit board
401 Optical circuit board layer
402,404 Waveguide

What is claimed is:

1. An optical transmission/reception device in which an optical transmission layer and an optical receiving layer are coupled in a direction perpendicular to the in-plane direction of the optical transmission layer,
wherein the optical transmission layer comprises, on the same substrate:
a laser light source that emits laser light;
an input-side waveguide optically coupled to the laser light source;
an optical frequency comb generator that generates an optical frequency comb from the laser light propagating through the input-side waveguide;
a demultiplexer that demultiplexes the optical frequency comb into individual optical frequency modes;
a plurality of branching waveguides that propagate the multiple demultiplexed light beams demultiplexed by the demultiplexer;
a plurality of intensity modulators that respectively modulate the intensity of the multiple demultiplexed light beams propagating through the plurality of branching waveguides;
a multiplexer for multiplexing the multiple modulated light beams intensity-modulated by the multiple intensity modulators;
a splitter that branches a part of each of the modulated light beams intensity-modulated by each of the intensity modulators or a part of the multiplexed light multiplexed by the multiplexer, and guides the branched light to a region above or below the substrate; and
an output-side waveguide which propagates the multiplexed light,
wherein the optical receiving layer comprises:
a receiving-side waveguide optically coupled to a waveguide of an external optical circuit;
a first light detection element that converts light propagating through the receiving-side waveguide into an electrical signal; and
a second light detection element that converts a part of each of the modulated light beams branched by the splitter or a part of the multiplexed light into an electrical signal.

2. The optical transmission/reception device according to claim 1, wherein the input-side waveguide, the plurality of branching waveguides, and the output-side waveguide include an ABX₃-type ferroelectric thin film.

3. The optical transmission/reception device according to claim 2, wherein
the ABX₃-type ferroelectric thin film is formed on the substrate, and
the input-side waveguide, the plurality of branching waveguides, and the output-side waveguide further include:
a first dielectric thin film that is formed directly on the ABX₃-type ferroelectric thin film; and
a second dielectric thin film that is formed on the first dielectric thin film and on the ABX₃-type ferroelectric thin film, and that covers an upper surface and side surfaces of the first dielectric thin film,
wherein a refractive index of the second dielectric thin film is lower than refractive indices of the ABX₃-type ferroelectric thin film and the first dielectric thin film.

4. The optical transmission/reception device according to claim 2, wherein
The ABX₃-type ferroelectric thin film is formed on the substrate, and
the input-side waveguide, the plurality of branching waveguides, and the output-side waveguide further include:
a third dielectric thin film that is formed on the ABX₃-type ferroelectric thin film;
a first dielectric thin film that is formed on the third dielectric thin film; and
a second dielectric thin film that is formed on the first dielectric thin film and on the third dielectric thin film, and that covers an upper surface and side surfaces of the first dielectric thin film,
wherein refractive indices of the second dielectric thin film and the third dielectric thin film are lower than refractive indices of the ABX₃-type ferroelectric thin film and the first dielectric thin film.

5. The optical transmission/reception device according to claim 2, wherein
the ABX₃-type ferroelectric thin film has a ridge-shaped portion that constitutes part of the input-side waveguide, the plurality of branching waveguides, and the output-side waveguide.

6. The optical transmission/reception device according to claim 1, wherein the splitter is any one of a meta-mirror, a diffraction grating, or a mirror.

7. The optical transmission/reception device according to claim 1, wherein the second light detection element is disposed directly above the splitter through a cladding of the optical transmission layer and a cladding of the optical receiving layer.

8. The optical transmission/reception device according to claim 7, wherein the cladding of the optical transmission layer and the cladding of the optical receiving layer are integrally formed.

9. The optical transmission/reception device according to claim 8, wherein the cladding is formed of SiO₂.

10. The optical transmission/reception device according to claim 2, wherein the ABX₃-type ferroelectric thin film is c-axis oriented lithium niobate.

11. The optical transmission/reception device according to claim 2, wherein the ABX₃-type ferroelectric thin film is a-axis oriented lithium niobate.

12. The optical transmission/reception device according to claim 2, wherein the substrate is a sapphire single crystal substrate.

13. The optical transmission/reception device according to claim 1, wherein the optical frequency comb generator includes a phase modulator that phase-modulates the laser light propagating through the input-side waveguide, and a first intensity modulator that intensity-modulates the laser light phase-modulated by the phase modulator.

14. The optical transmission/reception device according to claim 1, wherein the first light detection element and the second light detection element have a magnetic element including a first ferromagnetic layer, a second ferromagnetic layer, and a spacer layer sandwiched between the first ferromagnetic layer and the second ferromagnetic layer.

15. The optical transmission/reception device according to claim 14,
wherein the magnetic element further includes an upper electrode that is in contact with an upper surface of the magnetic element and a lower electrode that is in contact with a lower surface of the magnetic element, and
wherein the upper electrode and the lower electrode are optically transparent to light propagating through the receiving-side waveguide.

16. The optical transmission/reception device according to claim 15, wherein the upper electrode and the lower electrode include ITO, IZO, ZnO, or IGZO.

17. An optical transmission apparatus comprising the optical transmission/reception device according to claim 1, a semiconductor electronic circuit, and an optical circuit board having one or more optical circuit board layers,
wherein the optical circuit board is the external optical circuit,
the semiconductor electronic circuit outputs an intensity modulation signal for intensity modulating the multiple demultiplexed light beams propagating through the multiple branching waveguides,
the intensity modulation signal is input to the multiple intensity modulators, and at least one of the output-side waveguide and the receiving-side waveguide is optically coupled to the end face of the waveguide in the optical circuit board layer.

18. The optical transmission apparatus according to claim 17, wherein the optical circuit board has a multilayer structure consisting of two or more optical circuit board layers,
wherein the waveguides formed in each of the optical circuit board layers are optically coupled to each other by either a diffraction grating, a meta-mirror, or a mirror.

19. The optical transmission apparatus according to claim 17, wherein the waveguide of the optical circuit board is made of any of SiNₓ, LiNbO₃, and SiO₂.

20. The optical transmission apparatus according to claim 17, wherein the optical circuit board is equipped with any of a ring resonator, a Mach-Zehnder type modulator, a demultiplexer, and a multiplexer.
